(19) United States
(12) Patent Application Publication
(10) Pub. No.: US 2011/0115584 A1
(43) Pub. Date: May 19, 2011

(54) PERIODIC STRUCTURE

(75) Inventor: Yasuhito KIJI, Shizuoka (JP)

(73) Assignee: Toshiba Tec Kabushiki Kaisha, Tokyo (US)

(21) Appl. No.: 12/946,493

(22) Filed: Nov. 15, 2010

(30) Foreign Application Priority Data
Nov. 17, 2009 (JP) 2009-262348

(51) Int. Cl. H01P 1/22

(52) U.S. Cl. 333/81 R

(57) ABSTRACT

According to one embodiment, a periodic structure includes two types of LC resonance circuits or more. The phases of reflected waves by these two types of LC resonance circuits or more with regard to an incident wave includes a specific frequency are different for each type of the LC resonance circuit.

### CROSS-REFERENCE TO RELATED APPLICATIONS

This application is based upon and claims the benefit of priority from the prior Japanese Patent Application No. 2009-262348, filed on Nov. 17, 2009, the entire contents of which are incorporated herein by reference.

### FIELD

Embodiments described herein relate generally to a periodic structure that controls reflection of, for example, radio waves.

### BACKGROUND

In recent years, a commodity control system that controls the location of an object by attaching an RFID (Radio Frequency IDentification) tag to the object has been introduced. For example, an RFID tag is attached to a document and a specific ID is registered by associating with the document and then, the document is accommodated in a file cabinet. When searching an archive for a predetermined document, a user can shorten the search time by searching for the position of an RFID tag having the ID associated with the document using an RFID reader or handy reader installed on the file cabinet. As a result, inventory work can be shortened.

When a commodity control system is introduced, it is desirable to use an existing file cabinet as it is. However, if the existing file cabinet is structured with a metallic frame, a standing wave is generated by interference between radio waves of communication output from a reader and radio waves reflected by the file cabinet.

If the position of an RFID tag attached to a document matches that of a node of the standing wave, the strength of a signal from the reader becomes extremely weak so that the RFID tag may not be able to read a signal from the reader.

As a solution to the problem of difficulty in reading an RFID tag due to the presence of a standing wave, a method of pasting an electromagnetic absorber on an internal surface of the file cabinet is known. The electromagnetic absorber is designed by using a loss material having a function to convert electromagnetic energy into heat and fitting the quality and thickness of the loss material to a desired frequency.

Also, a ¼-wavelength electromagnetic absorber is known. The ¼-wavelength electromagnetic absorber has a resistance film provided in the position of a 1/4 wavelength of a reflected wave from the reflecting surface. However, the ¼-wavelength electromagnetic absorber requires the thickness of the ¼ wavelength of a desired frequency. In the case of, for example, one UHF band of frequency bands used for RFID, the length of ¼ wavelength in the air is about 8 cm.

As a ¼-wavelength electromagnetic absorber, a structure with a reduced thickness is proposed by arranging a patch element between the resistance film and the reflecting surface (see, for example, Jpn. Pat. Appln. KOKAI Publication No. 2004-140194).

### BRIEF DESCRIPTION OF THE DRAWINGS

FIG. 1 is a perspective view showing a file cabinet in which a periodic structure according to a first embodiment is provided;

FIG. 2 is a perspective view showing a state in which a portion of the periodic structure shown in FIG. 1 is cut out;

FIG. 3 is a sectional view showing the state in which the periodic structure is cut along an F3-F3 line shown in FIG. 2;

FIG. 4 is a perspective view showing the state in which a portion of the periodic structure according to a second embodiment is cut out;

FIG. 5 is a plan view showing a portion of the periodic structure according to a third embodiment;

FIG. 6 is a graph showing a simulation result of an x-axis component of an electric field 1 mm over the surface of the periodic structure shown in FIG. 5;

FIG. 7 is a graph showing a simulation result of frequency characteristics of power attenuation of reflected waves at a position 157 mm over the surface of the periodic structure shown in FIG. 5;

FIG. 8 is a plan view showing a portion of the periodic structure according to a fourth embodiment;

FIG. 9 is a graph showing a simulation result of frequency characteristics of power attenuation of reflected waves at a position 157 mm over the surface of the periodic structure shown in FIG. 8;

FIG. 10 is a perspective view showing the state in which a portion of the periodic structure according to a fifth embodiment is cut out;

FIG. 11 is a sectional view of the periodic structure showing along an F11-F11 line shown in FIG. 10;

FIG. 12 is a schematic diagram showing a charge distribution and electric lines of force (electric field) at some instant of the periodic structure shown in FIG. 10;

FIG. 13 is a perspective view showing the state in which a portion of the periodic structure according to a sixth embodiment is cut out;

FIG. 14 is a perspective view showing the state in which a portion of the periodic structure according to a seventh embodiment is cut out;

FIG. 15 is a plan view showing a portion of the periodic structure according to an eighth embodiment;

FIG. 16 is a sectional view of the periodic structure showing a portion of a second patch layer of the periodic structure shown in FIG. 15;

FIG. 17 is a graph showing a simulation result of an x-axis component of an electric field 1 mm over the surface of the periodic structure shown in FIG. 15;

FIG. 18 is a graph showing a simulation result of frequency characteristics of power attenuation of reflected waves at a position 157 mm over the surface of the periodic structure shown in FIG. 15;

FIG. 19 is a plan view showing a portion of the periodic structure according to a ninth embodiment;

FIG. 20 is a sectional view of the periodic structure showing a portion of the second patch layer of the periodic structure shown in FIG. 19;

FIG. 21 is a graph showing a simulation result of frequency characteristics of power attenuation of reflected waves at a position 157 mm over the surface of the periodic structure shown in FIG. 19;

FIG. 22 is a plan view showing a portion of the periodic structure according to a tenth embodiment;

FIG. 23 is a sectional view of the periodic structure showing a portion of a second patch layer of the periodic structure shown in FIG. 22;

FIG. 24 is a graph showing a simulation result of frequency characteristics of power attenuation of reflected waves at a position 157 mm over the surface of the periodic structure shown in FIG. 22;

FIG. 25 is a plan view showing a portion of the periodic structure according to an eleventh embodiment;

FIG. 26 is a sectional view of the periodic structure showing a portion of a second patch layer of the periodic structure shown in FIG. 25;

FIG. 27 is a graph showing a simulation result of frequency characteristics of power attenuation of reflected waves at a position 157 mm over the surface of the periodic structure shown in FIG. 25;

FIG. 28 is a plan view showing a portion of the periodic structure according to a twelfth embodiment;

FIG. 29 is a sectional view of the periodic structure showing the second patch layer of the periodic structure shown in FIG. 28;

FIG. 30 is a graph showing a simulation result of frequency characteristics of power attenuation of reflected waves at a position 157 mm over the surface of the periodic structure shown in FIG. 28;

FIG. 31 is a graph showing a simulation result of frequency characteristics of power attenuation of reflected waves at a position 157 mm over the surface of the periodic structure according to a thirteenth embodiment;

FIG. 32 is a plan view showing a portion of the periodic structure according to a fourteenth embodiment;

FIG. 33 is a plan view showing a portion of the periodic structure according to a fifteenth embodiment;

FIG. 34 is a plan view showing a portion of the periodic structure according to a sixteenth embodiment;

FIG. 35 is a graph showing a simulation result of frequency characteristics of power attenuation of reflected waves at a position 157 mm over the surface of the periodic structure shown in FIG. 34;

FIG. 36 is a sectional view of the periodic structure showing the state in which the periodic structure according to a seventeenth embodiment is cut in a lamination direction;

FIG. 37 is a schematic diagram showing how LC resonance circuits of the periodic structure according to an eighteenth embodiment are formed;

FIG. 38 is a perspective view showing the periodic structure according to the eighteenth embodiment by cutting out a portion thereof;

FIG. 39 is a graph showing a result of an experiment to measure a reading distance of an RFID tag to the periodic structure of the periodic structure shown in FIG. 38;

FIG. 40 is a schematic diagram showing conditions for the experiment in FIG. 39;

FIG. 41 is a perspective view showing an EBG used for the experiment shown in FIG. 40;

FIG. 42 is a sectional view of the EBG showing along an F42-F42 line shown in FIG. 41;

FIG. 43 is a sectional view of the periodic structure showing the state in which the periodic structure according to a nineteenth embodiment is cut in the lamination direction;

FIG. 44 is a sectional view of the periodic structure showing the state in which the periodic structure according to a twentieth embodiment is cut in the lamination direction;

FIG. 45 is a sectional view of the periodic structure showing along an F45-F45 line shown in FIG. 44;

FIG. 46 is a graph showing a simulation result of frequency characteristics of power attenuation of reflected waves at a position 157 mm over the surface 11 of the periodic structure shown in FIG. 44; and

FIG. 47 is a graph showing a simulation result of an x-axis component of an electric field 1 mm over the surface of the periodic structure shown in FIG. 34.

### DETAILED DESCRIPTION

In general, according to one embodiment, a periodic structure includes two types of LC resonance circuits or more. The phases of reflected waves by these two types of LC resonance circuits or more with regard to an incident wave comprising a specific frequency are different for each type of the LC resonance circuit.

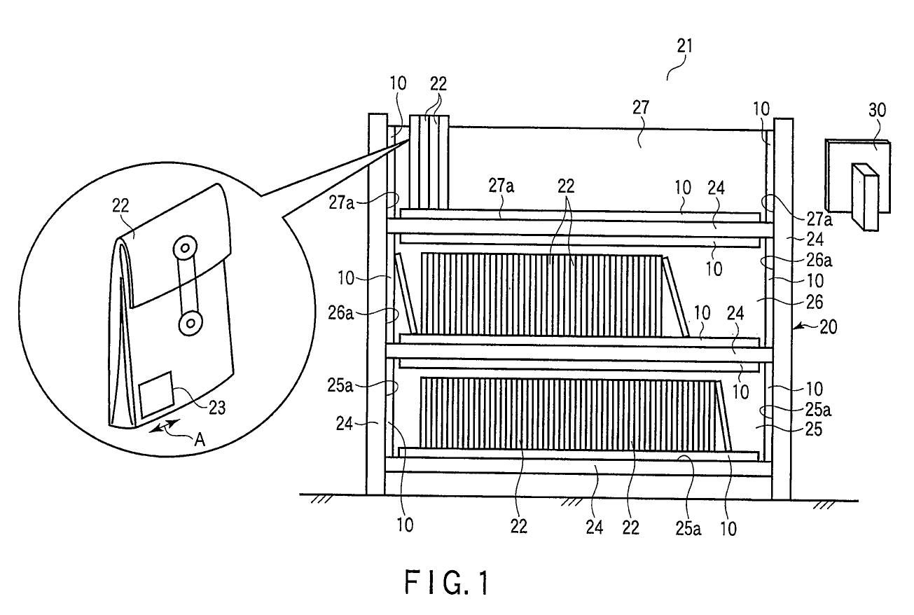

A periodic structure according to the first embodiment will be described using FIGS. 1 to 3. FIG. 1 is a perspective view showing a file cabinet 20 in which a periodic structure 10 according to the present embodiment is provided. For example, a plurality of file cabinets is provided inside an archive 21 and the file cabinet 20 is one of the plurality of file cabinets.

As shown in FIG. 1, a plurality of documents 22 is stored in the file cabinet 20. Each of the documents 22 has, as shown as an enlarged view in FIG. 1, an RFID (Radio Frequency IDentification) tag 23 provided thereon.

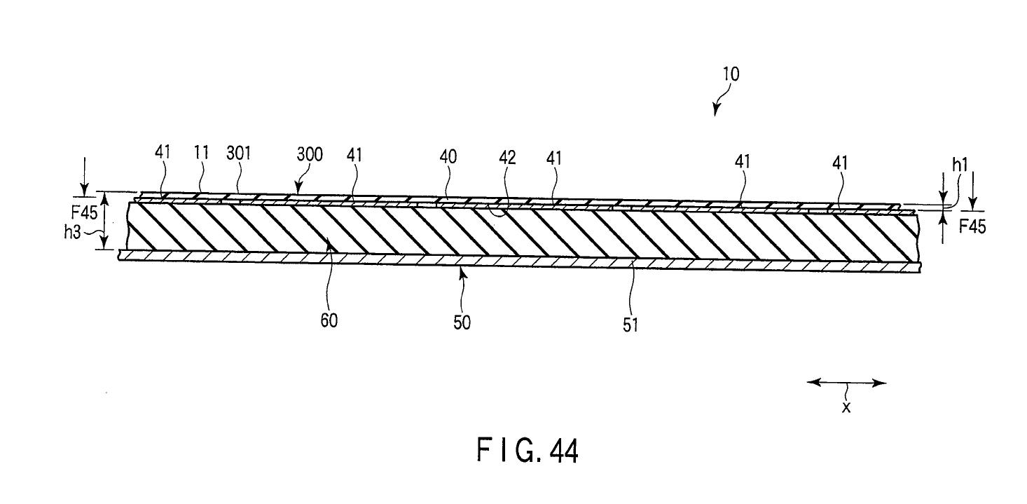

The file cabinet 20 in which the periodic structure 10 is provided is used for a commodity control system that controls locations of these documents 22. Each of the documents 22 has the RFID tag 23 attached thereto and is accommodated in the file cabinet 20 after a specific ID being associated with the document 22 and registered. When a user of documents searches for a specific document, the user searches for the position of an RFID tag having the ID associated with the document by using an RFID reader (shown in FIG. 44) or a handy reader (not shown).

More specifically, an electromagnetic wave of a specific frequency is output from a wand antenna 30 shown in FIG. 1 by operating the RFID reader or the handy reader. In the present embodiment, 953 MHz in the UHF band is used as an example. 953 MHz is an example of the specific frequency in the present embodiment. An RFID tag receives the electromagnetic wave and also outputs a specific ID signal of the RFID tag. The reader reads the specific ID signal. The search time of document can thereby be shortened.

The file cabinet 20 is structured with a metallic frame 24 and includes, for example, first to third accommodation spaces 25, 26, and 27. The first to third accommodation spaces 25 to 27 are arranged vertically.

The periodic structure 10 is pasted and fixed to internal surfaces 25a, 26a, and 27a of the first to third accommodation spaces 25 to 27. The periodic structure 10 has a size substantially appropriate to sizes of the internal surfaces 25a to 27a where the periodic structure 10 is pasted. Thus, substantially the entire region of the internal surfaces 25a to 27a is covered with the periodic structure 10. Incidentally, instead of substantially the entire region of each of the internal surfaces 25a to 27a, the entire region of each of the internal surfaces 25a to 27a may be covered with the periodic structure 10.

The periodic structure 10 has a function to inhibit an electromagnetic wave output from the wand antenna 30 from becoming a standing wave by interfering with reflected waves from the internal surfaces 25a to 27a of the first to third accommodation spaces 25 to 27.

The periodic structure 10 will be described. The periodic structures 10 pasted on the internal surfaces 25a to 27a of the first to third accommodation spaces 25 to 27 each have a different size, but the structure thereof is the same.

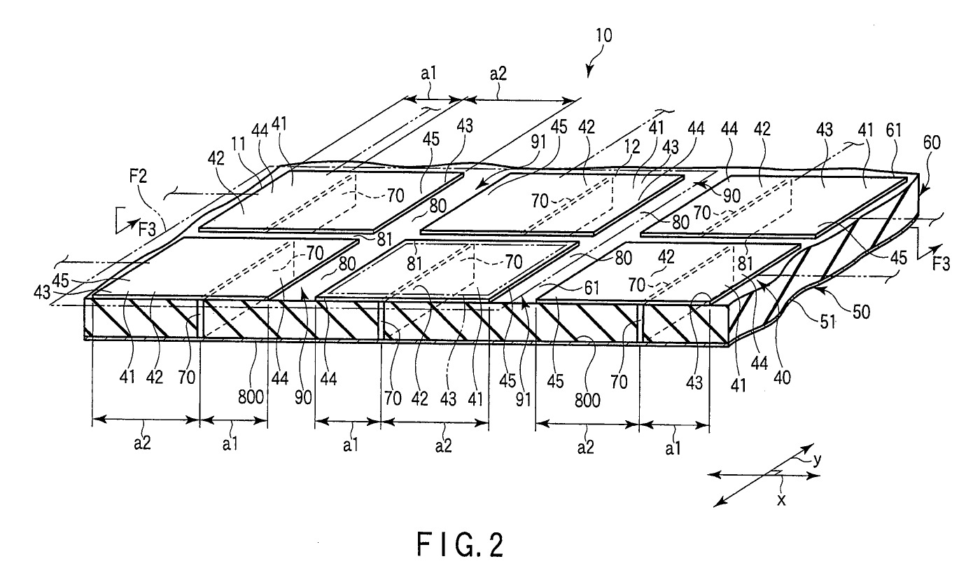

FIG. 2 is a perspective view of the periodic structure 10 by cutting out a portion thereof. As shown in FIG. 2, the periodic structure 10 includes a patch layer 40 including a plurality of conductor patches 41, a ground layer 50, an insulating layer 60, and a connecting conductor. The periodic structure 10 is arranged in such a way that the ground layer 50 faces the internal surfaces 25a to 27a.

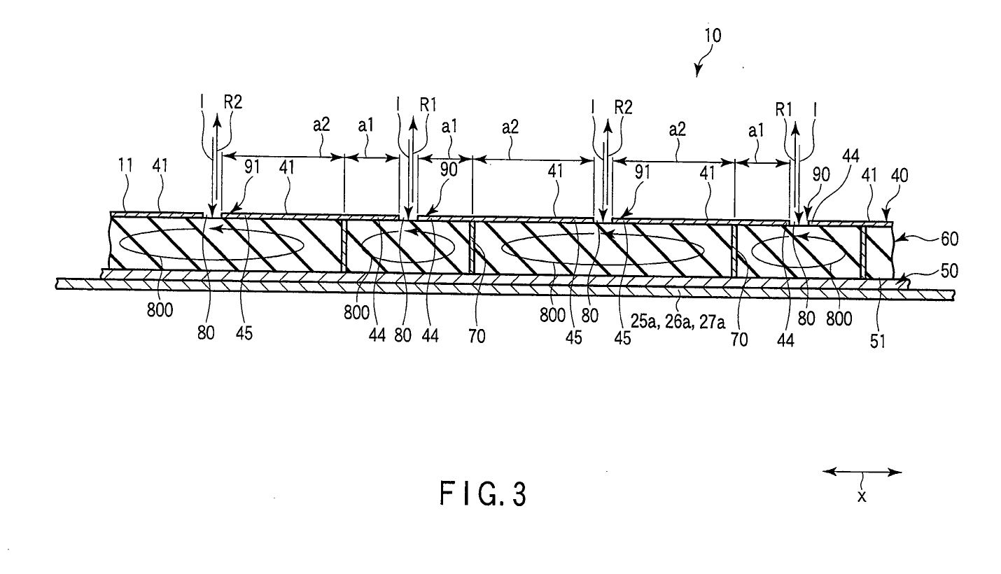

FIG. 3 is a sectional view of the periodic structure 10 taken along the F3-F3 line shown in FIG. 2. The patch layer 40 includes the plurality of metallic flat conductor patches 41. As shown in FIGS. 2 and 3, each of the conductor patches 41 has the same structure (shape). As shown in FIG. 2, the flat shape of the conductor patch 41 is quadrangular and the each angle of the four angles is 90 degrees.

The conductor patches 41 adjacent to each other are spaced apart from each other. The conductor patches adjacent to each other are arranged in such a way that sides opposite to each other are parallel. Thus, the conductor patches 41 are placed side by side in one direction and a direction perpendicular to the one direction. In the present embodiment, for the sake of convenience, the one direction is assumed to be a direction along an x axis direction, in other words, a direction parallel with the x axis direction (hereinafter, called the x axis direction) and the other direction (the other direction is perpendicular to the one direction) to be a direction along a y axis direction, in other words, a direction parallel with the y axis direction (hereinafter, called the y axis direction). A surface 42 exposed to the outside of the conductor patch 41 is made to be flush.

In other words, the conductor patches 41 are arranged in such a way that a pair of side sections (edges) opposite to each other of the conductor patches 41 is parallel to the x axis direction and a pair of side sections that are different from the above pair of side sections and opposite to each other is parallel to the y axis direction. Then, sides along the x axis direction in a circumference of the conductor patches 41 placed side by side on one line in the x axis direction are arranged on the same straight line (parallel to the x axis direction). Similarly, sides along the y axis direction in a circumference of the conductor patches 41 placed side by side on one line in the y axis direction are arranged on the same straight line (parallel to the y axis direction). The conductor patches 41 are spaced so as not to come into contact with the other conductor patches 41 adjacent to each other in the x-axis x and y axis directions.

FIG. 2 shows a portion of the conductor patches 41 and the other conductor patches 41 placed in the x-axis x and y axis directions are omitted with a double-dashed chain line.

The ground layer 50 is constituted of a ground plate 51. The ground plate 51 is a metallic flat member. The ground layer 50 constituted of the ground plate 51 is arranged opposite to the patch layer 40 and separated from the patch layer 40 (each of the conductor patches 41 does not come into contact with the ground plate 51 directly).

The insulating layer 60 is constituted of a dielectric material. The insulating layer 60 is stacked on the ground layer 50 and the patch layer 40 is stacked on the insulating layer 60. One end of the insulating layer 60 is in contact with the patch layer 40 and the other end thereof is in contact with the ground layer 50. In the present embodiment, the periodic structure 10 is formed of, as an example, a substrate having a copper foil layer formed on both sides. The patch layer 40 is formed by removing other portions than the conductor patches 41 from the copper foil layer provided on one surface of the insulating layer 60. The other copper foil layer becomes the ground layer 50. Thus, a surface 61 of the insulating layer 60 and the surface 42 of the patch layer 40 are not flush.

In the present embodiment, a plate-type connecting conductor 70 is used as the connecting conductor. One plate-type connecting conductor 70 is provided on one conductor patch 41 to electrically connect to the conductor patch 41 and the ground plate 51 and electrically connects the patch layer 40 and the ground layer 50. The plate-type connecting conductor 70 has a plate shape with a fixed thickness and extends in parallel with the y axis direction from one end of the conductor patch 41 in the y axis direction to the other end. Also, the plate-type connecting conductor 70 is connected to a portion of the ground plate 51. The portion overlaps a range extending in the direction in which the patch layer 40 and the insulating layer 60 are stacked. The range is from the one end of the conductor 41 in the Y axis direction to the other end of the conductor 41 in the Y axis direction.

Thus, the plate-type connecting conductor 70 is electrically connected to a contour portion 43 of the conductor patch 41 and consequently, the contour portion 43 of the conductor patch 41 and the ground plate 51 are electrically connected. The contour portion 43 is a contour (edge portion) of the conductor patch 41 and, in FIG. 2, the contour portion 43 is indicated, as an example, by a double-dashed chain line in one conductor patch 41.

The periodic structure 10 has a gap 80 functioning as a capacitor defined between the conductor patches 41 adjacent to each other in the x axis direction. More specifically, side sections (contour portion 43) opposite to each other in the conductor patches 41 function as a capacitor. In the present embodiment, the interval of the gap 80 is the same. The interval of the gap 80 is also constant in the y direction. The intervals of a gap 81 between the conductor patches 41 adjacent to each other in the y axis direction are all the same and also constant in the direction in which the gap 81 extends (x axis direction).

For the gap 80 to function as a capacitor, it is assumed that an electromagnetic wave incident on the periodic structure 10 contains a polarization component in the x axis direction.

The two conductor patches 41 defining one gap 80 are electrically connected to the plate-type connecting conductor 70 by a direct current via the ground plate 51. As shown in FIG. 3, a current path 800 (the conductor patches 41, the plate-type connecting conductor 70, and the ground plate 51) that electrically connects the pair of conductor patches 41 related as described above by the direct current function as a coil. Thus, an LC resonance circuit is constituted of the conductor patches 41 adjacent to each other in the x axis direction. The periodic structure 10 is a structure formed by aggregating a plurality of LC resonance circuits.

The periodic structure 10 is configured to be able to reflect a first reflected wave R1 and a second reflected wave R2 when the periodic structure 10 reflects an electromagnetic wave incident on the surface 11 (the surface 42 of the patch layer 40 in the present embodiment). The first and second reflected waves R1 and R2 have the same frequency and a phase difference of 180 degrees. In the present embodiment, as an example, the first reflected wave R1 has a phase shifted by 90 degrees with regard to the incident wave. The second reflected wave R2 has a phase shifted by 270 degrees with regard to the incident wave.

In the present embodiment, as shown in FIG. 2, each of the conductor patches 41 has the same shape. The interval of the gap 80 defined between the conductor patches 41 adjacent to each other in the x axis direction is the same for all the gaps 80 and also constant in the y axis direction.

Inside the conductor patch 41, the plate-type connecting conductor 70 extends in the y axis direction in parallel to connect both ends thereof. The plate-type connecting conductor 70 is arranged in the x axis direction in such a way that the distance from one end to the center thereof in the x axis direction is a first distance a1 and the distance from the other end to the center thereof in the x axis direction is a second distance a2. The first distance a1 and the second distance a2 are different. The one end defining the first distance a1 is set as a first end 44 and the other end defining the second distance a2 as a second end 45. The conductor patches 41 are arranged in such a way that the first ends 41 face each other in the X axis direction. And the conductor patches 41 are arranged in such a way that the second ends 45 face each other in the X axis direction.

Thus, LC resonance circuits whose distance of the current path 800 functioning as a coil is mutually different are alternately arranged in the x axis direction. In other words, an LC resonance circuit set so that the first ends 44 face each other and an LC resonance circuit set so that the second ends 45 are adjacent to each other change alternately in the x axis direction.

An LC resonance circuit configured by the first ends 44 being arranged facing each other is set as a first LC resonance circuit 90 and an LC resonance circuit configured by the second ends 45 being arranged facing each other as a second LC resonance circuit 91.

The first LC resonance circuit 90 is set to reflect the first reflected wave R1. The second LC resonance circuit 91 is set to reflect the second reflected wave R2. The first and second LC resonance circuits 90 and 91 are LC resonance circuits having mutually different phases of reflected waves with regards to an incident wave.

Shapes and dimensions of components constituting the first and second LC resonance circuits 90 and 91 such as the size of the conductor patch 41, the interval of the gap 80, the first distance a1, and the second distance a2 are set so that the first LC resonance circuit 90 reflects the first reflected wave R1 and the second LC resonance circuit 91 reflects the second reflected wave R2.

The first and second LC resonance circuits 90 and 91 are arranged alternately in the x-axis x and y axis directions. In FIG. 2, a unit element 12 of the periodic structure 10 is shown within a range of F2 indicated by a double-dashed chain line. In the present embodiment, the unit element 12 includes a total of four LC resonance circuits of two types, a pair of the first and second LC resonance circuits 90 and 91 adjacent to each other in the x-axis direction and the first and second LC resonance circuits 90 and 91 adjacent to each other in the y-axis direction.

Next, the operation of the periodic structure 10 will be described. As shown in FIG. 1, when an operator operates a reader (not shown) to search for the intended document 22, an electromagnetic wave is output from the wand antenna 30. The electromagnetic wave output from the wand antenna 30 includes a portion that directly reaches the RFID tag 23 provided on the document 22 and a portion sent toward the internal surfaces 25a to 27a of the file cabinet 20. The periodic structure 10 is pasted on substantially the entire region of the internal surfaces 25a to 27a. The electromagnetic wave sent toward the internal surfaces 25a to 27a reaches the periodic structure 10.

FIG. 3 shows a state in which an electromagnetic wave is incident on the surface 11 of the periodic structure 10. As shown in FIG. 3, an incident wave I enters each of the gaps 80 and then, is reflected. At this point, the incident wave I that enters the gap 80 constituting the first LC resonance circuit 90 is reflected as the first reflected wave R1. The incident wave I that enters the gap 80 constituting the second LC resonance circuit 91 is reflected as the second reflected wave R2.

This point will be described more specifically. In a periodic structure that has substantially the same structure as the periodic structure 10 except that the plate-type connecting conductor 70 is not included, an incident wave entering each gap moves between the patch layer and the ground layer so that reflection of the incident wave occurs also through other gaps than the incident gap.

In other words, a reflected wave reflected through a specific gap is affected by incident waves that have entered other gaps. Thus, it becomes more difficult to control phase shifts of reflected waves with regard to the incident wave.

However, the periodic structure 10 includes the plate-type connecting conductor 70. The plate-type connecting conductor 70 functions as a wall to shield an influence of the incident wave I that has entered the other gaps 80. Thus, the reflected waves R1 and R2 reflected by one of the gaps 80 are constituted of only the incident wave I that has entered the gap 80.

Therefore, the phase shift of a reflected wave with regard to the incident wave I can be controlled by individual LC resonance circuits. The present embodiment is designed in such a way that the first and second reflected waves R1 and R2 can be reflected by the first and second LC resonance circuits 90 and 91, respectively.

The periodic structure 10 has the first and second LC resonance circuits 90 and 91 alternately arranged along the x-axis x and y axis directions and thus, the first and second reflected waves R1 and R2 are alternately reflected. Since the phase difference between the first and second reflected waves R1 and R2 is 180 degrees, the first and second reflected waves R1 and R2 cancel out each other. As a result, a reflected wave reflected from the periodic structure 10 is controlled.

With a reflected wave from the periodic structure 10 being controlled, a standing wave caused by interference between a reflected wave and an incident wave will not be generated. Thus, a node where the signal strength becomes extremely weak will not arise and lack of reception at the RFID tag 23 of an electromagnetic wave output from the wand antenna 30 can be controlled.

Thus, in the present embodiment, the periodic structure 10 reflects the first and second reflected waves R1 and R2 and due to interference of the first and second reflected waves R1 and R2, a reflected wave reflected by the periodic structure 10 is controlled. Consequently, generation of a standing wave caused by interference between a reflected wave and an incident wave can be controlled.

Therefore, the periodic structure 10 does not use a loss material and resistance film with a large loss that makes electromagnetic energy sufficiently small for the purpose of controlling an occurrence of a standing wave by interference between a reflected wave and an incident wave. As a result, the cost of the periodic structure 10 can be held down, which makes the introduction of the periodic structure 10 easier and, consequently, it becomes possible to control electromagnetic interference by a reflected wave and to improve the environment of communication.

The present embodiment has a structure in which the periodic structure 10 includes the first and second LC resonance circuits 90 and 91. However, the present embodiment is not limited to this. For example, a plurality of types, which are not two types, of LC resonance circuits such as three or four types may be included.

Even in this case, the phase shift of a reflected wave with regard to an incident wave is adjusted in the plurality of types of LC resonance circuits by each structure being adjusted (for example, by adjusting the length of a current path functioning as a coil like in the present embodiment). The plurality of types of LC resonance circuits is designed so that reflected waves interfere to cancel out each other.

Thus, by adopting a structure including two types of LC resonance circuits or more, a reflected wave is controlled and consequently, generation of a standing wave by an incident wave and a reflected wave is controlled.

The present embodiment is formed by assuming that an incident wave of the first and second LC resonance circuits 90 and 91 contains a polarization component in the x axis direction, but the present embodiment is not limited to this. For example, by arranging the plate-type connecting conductor 70 along the x axis direction, as an example, to connect both ends (contour portion 43) of the plate-type connecting conductor 70 in the x axis direction, an LC resonance circuit in which the gap 81 between the conductor patches 41 adjacent to each other in the y axis direction functions as a capacitor and capable of handling a polarization component can be configured. Also in this case, like the above one, the same operation and effect can be obtained by forming a plurality of LC resonance circuits by adjusting the position of the plate-type connecting conductor 70 or the like and generating reflected waves having a plurality of phase differences to cancel out each of these reflected waves.

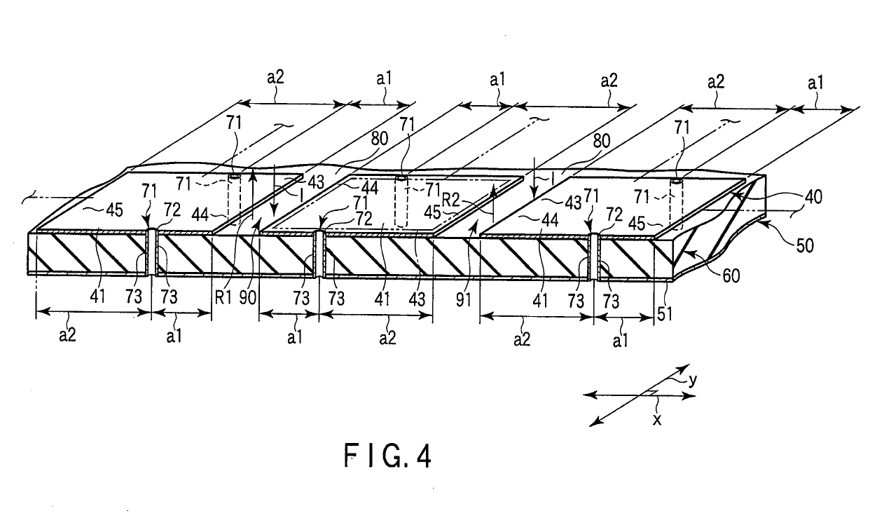

Next, the periodic structure according to the second embodiment will be described using FIG. 4. The same reference numerals are attached to components having the similar functions as those in the first embodiment and a description thereof is omitted. In the present embodiment, the connecting conductor is different from that in the first embodiment. The remaining structure may be the same as that in the first embodiment. The above different structure will be described.

FIG. 4 is a perspective view showing the periodic structure 10 according to the present embodiment by cutting out a portion thereof. As shown in FIG. 4, instead of the plate-type connecting conductor 70, a via 71 is used in the present embodiment. The via 71 is electrically connected to the contour portion 43 of the conductor patch 41 and the ground plate 51.

The via 71 is a portion of the contour portion 43 of the conductor patch 41 along the x axis direction and one unit thereof is arranged at a position whose distance from the first end 44 is the first distance a1 and whose distance from the second end 45 is the second distance a2.

The via 71 is formed by a conductive material 73 being provided inside a hole 72 cutting through the conductor patch 41 (patch layer 40), the insulating layer 60, and the ground plate 51 (ground layer 50). Thus, the via 71 has a hole cutting through from the conductor patch 41 to the ground plate 51 (including the ground plate 51) formed in the center section thereof. The flat shape of the hole 72 is, for example, circular. The diameter of the via 71 is, as an example, 2 mm.

The distance from the first end 44 to the center of the via 71 becomes the first distance a1 and the distance from the second end 45 to the center of the via 71 becomes the second distance a2. Thus, like the first embodiment, the first and second LC resonance circuits 90 and 91 are alternately arranged in the x-axis x and y axis directions.

The patch layer 40 and the ground layer 50 are mutually electrically connected by the conductor patch 41, the via 71 (conductive material), and the ground plate 51 being mutually electrically connected.

The via 71 functions, like the plate-type connecting conductor 70 described in the first embodiment, as a wall. This point will be described more specifically. A current caused in the conductor patch 41 after the high-frequency incident wave I being incident flows along the contour portion 43 of the conductor patch 41. With the via 71 as a connecting conductor being arranged in the contour portion 43 like in the present embodiment, the via 71 functions as a wall described in the first embodiment.

Thus, the present embodiment can obtain the same operation and effect as those in the first embodiment.

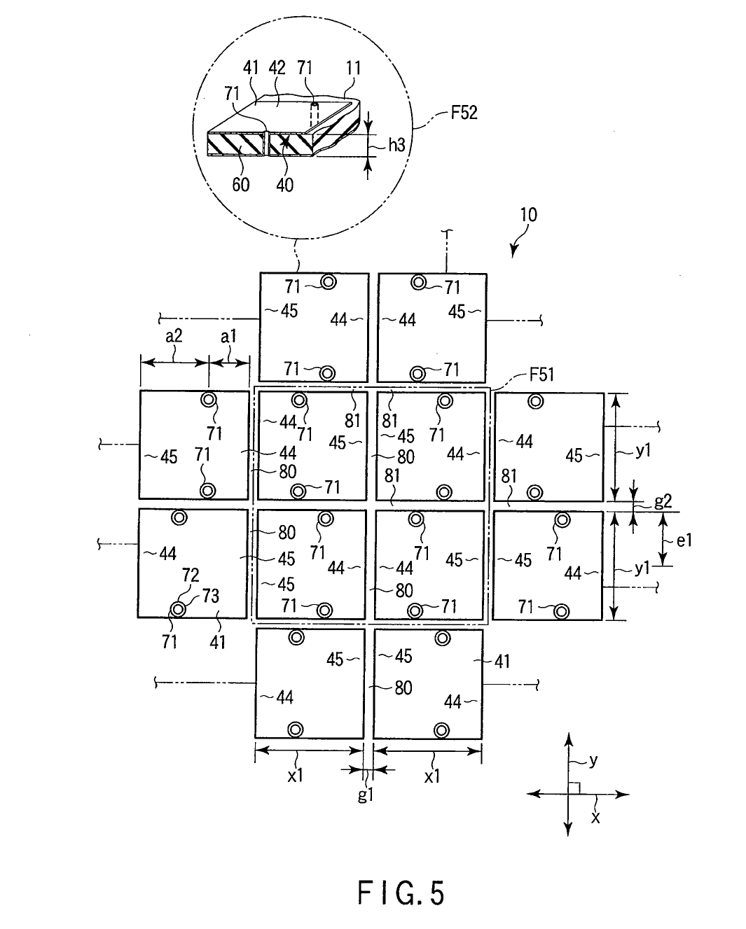

Next, the periodic structure according to the third embodiment will be described using FIGS. 5 to 7. The same reference numerals are attached to components having the similar functions as those in the second embodiment and a description thereof is omitted. In the present embodiment, the periodic structure 10 has the same structure as that of the periodic structure 10 described in the second embodiment. In the present embodiment, dimensions of the periodic structure 10 described in the second embodiment are set to predetermined values and further, a simulation of frequency characteristics of power attenuation of a reflected wave is performed.

FIG. 5 is a plan view showing a portion of the periodic structure 10. In FIG. 5, the four conductor patches 41 constituting the unit element 12 are enclosed with a double-dashed chain line F51. An incident wave incident on the periodic structure 10 contains a linear polarization component along the x axis direction. A wave obtained by subtracting incident wave components from a synthesized wave of an incident wave and reflected waves calculated by the simulation at a position 157 mm over the surface 11 of the periodic structure 10 is defined as a reflected wave. Then, the reflected wave and the incident wave are compared to calculate the power attenuation of the reflected wave. Incidentally, 157 mm is a half wavelength of an electromagnetic wave (as an example, 953 MHz) output from the wand antenna 30.

The wavelength of an electromagnetic wave output from the wand antenna 30 is a so-called specific frequency and thus, 953 MHz is an example of the specific frequency in the present embodiment.

In the present embodiment, the dielectric constant of the insulating layer 60 is 4.4 and the dielectric dissipation factor thereof is 0.018. The length of the conductor patch 41 along the x axis direction is set as x1 and the length of the conductor patch 41 along the y axis direction as y1. In the present embodiment, x1 is 27 mm and y1 is 27 mm. The interval of the gap 80 between the conductor patches 41 adjacent to each other in the x axis direction is set as g1 and the interval of the gap 81 between the conductor patches 41 adjacent to each other in the y axis direction as g2. In the present embodiment, g1 is 1 mm and g2 is 1 mm.

A state in which a portion of the periodic structure 10 is cut out is shown within the range indicated by a double-dashed chain line F52 in FIG. 5. As shown here, the depth from the surface 11 (in the present embodiment, the surface 42 of the conductor patch 41 of the patch layer 40) to the upper surface (surface opposite to the insulating layer) of the ground layer 50 is set as h3. In the present embodiment, h3 is 6.4 mm. In the present embodiment, the first distance a1 is 9.5 mm.

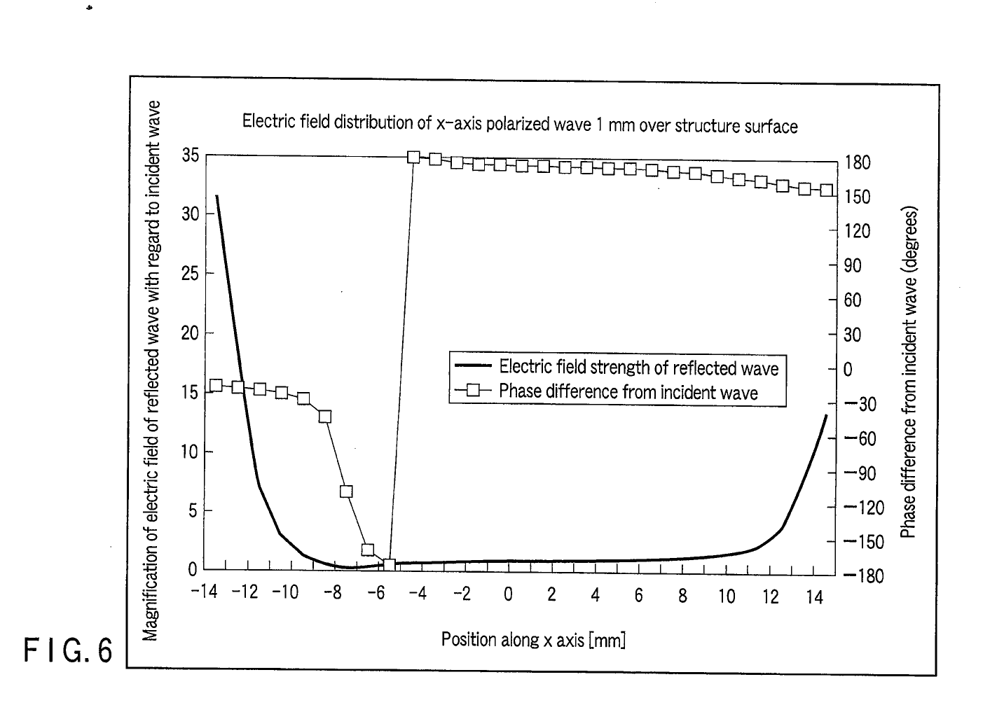

FIG. 6 is a graph showing a simulation result of the x-axis component of an electric field 1 mm over the surface 11 (surface 42) (in the direction opposite to the direction toward the ground layer 50) of the periodic structure 10 and, as shown in FIG. 5, at an intermediate position e1=13.5 mm in the y axis direction of the conductor patch 41. FIG. 6 shows a simulation result near the one conductor patch 41.

The horizontal axis in FIG. 6 shows the position along the x axis direction of the conductor patch 41 and the unit thereof is mm. One direction of the direction along the x axis direction is defined as positive and the other direction as negative. 0 indicates the center position (position of 13.5 mm from both ends) of the conductor patch 41. The vertical axis in FIG. 6 shows the magnification of an electric field of a reflected wave along the x axis direction with regard to an incident wave at a position 1 mm over the surface 11 (in the direction opposite to the direction toward the ground layer 50).

As shown in FIG. 6, the electric field strength of the reflected wave in the center position (0 position) of the conductor patch 41 is about 1 (100%) and the phase difference with regard to an incident wave is about 180 degrees. At positions of 13.5 mm and −13.5 mm indicating the positions of the gap 80 between the conductor patches 41 adjacent to each other in the x axis direction, the electric field of the reflected wave is strong.

At the position of 13.5 mm, the phase difference of a reflected wave (for example, the first reflected wave R1) with regard to the incident wave I is substantially −30 degrees and at the position of −13.5 mm, the phase difference of a reflected wave (for example, the second reflected wave R2) with regard to the incident wave I is substantially 150 degrees so that the phase difference between the gaps 80 adjacent to each other in the x axis direction is substantially 180 degrees.

One (the first reflected wave R1) of reflected waves in the gap 80 between the conductor patches 41 adjacent to each other in the x axis direction has, as described above, the phase difference of substantially −30 degrees with regard to the incident wave. That is, this is a value within the range of −90 degrees or more and 90 degrees or less.

A reflected wave reflected by a metal plate normally has a phase difference of about 180 degrees with regard to the incident wave. Thus, if reflected waves should cancel each other out, it is desirable to adjust the phase difference of a reflected wave of at least one LC resonance circuit among a plurality of LC resonance circuits with regard to the incident wave to a value in the range of −90 degrees or more and 90 degrees or less at a desired frequency (in the present embodiment, 953 MHz).

It is evident from the above simulation result that reflected waves having periodically different reflection phases are reflected by the periodic structure 10 in the present embodiment. Thus, reflected waves having locally different phases cancel each other out at a position separated from the surface 11 of the periodic structure 10 in the present embodiment so that reflected waves are controlled.

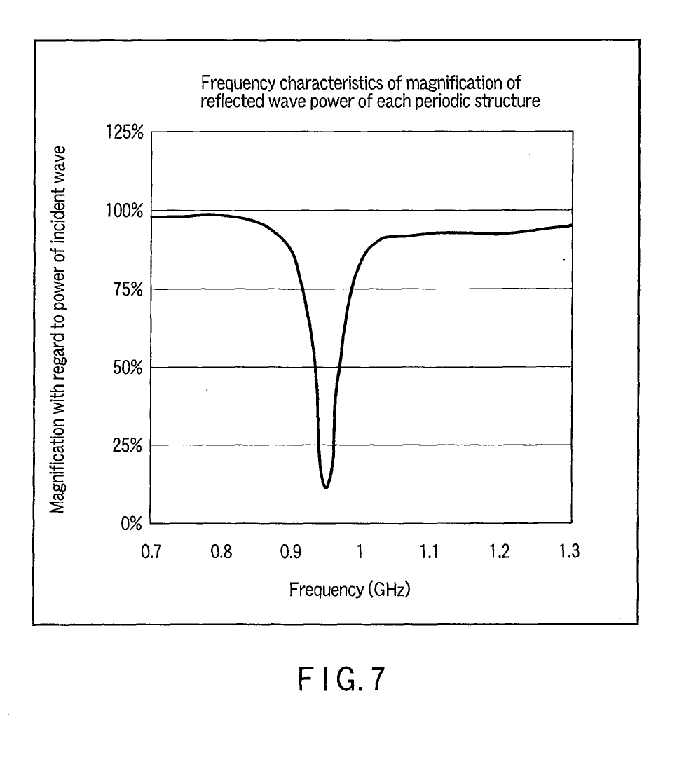

FIG. 7 shows a simulation result of frequency characteristics of power attenuation of a reflected wave at a position 157 mm over the surface 11 (in the direction opposite to the direction toward the ground layer 50) of the periodic structure 10. As shown in FIG. 7, it is evident that the power of the reflected wave is small near 953 MHz. FIG. 7 shows a simulation result designed to be able to control a reflected wave when the periodic structure 10 uses a frequency of 953 MHz as the incident wave I.

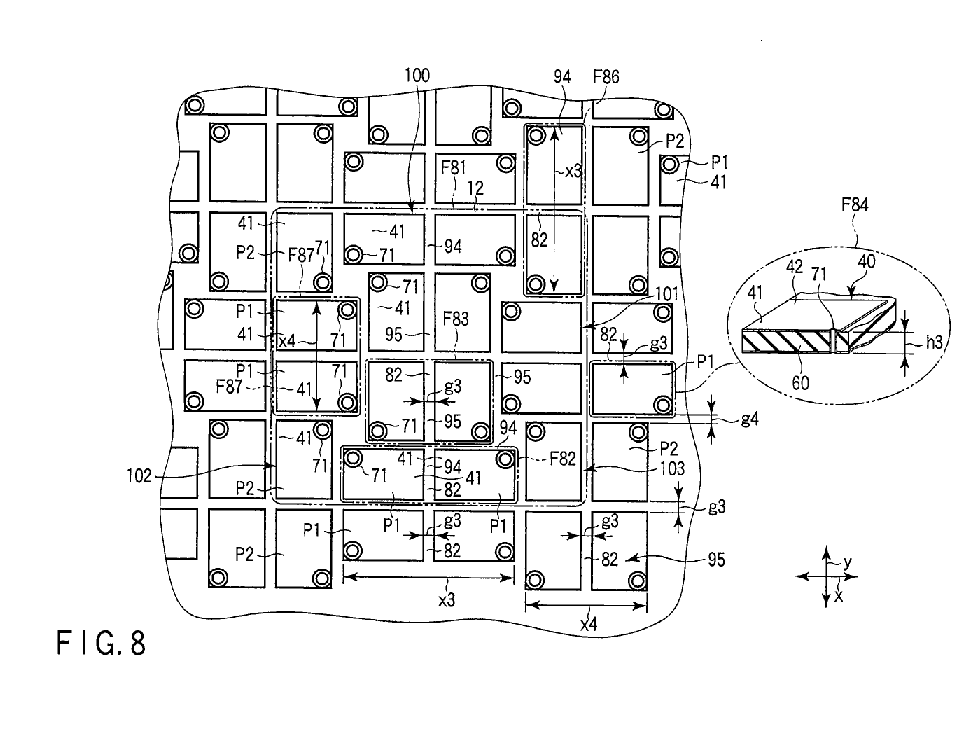

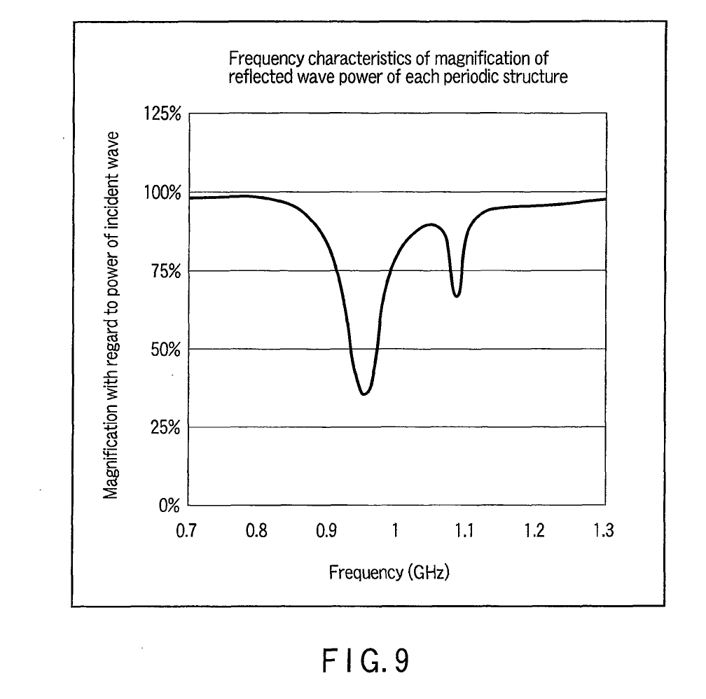

Next, the periodic structure according to the fourth embodiment will be described using FIGS. 8 and 9. The same reference numerals are attached to components having the similar functions as those in the first embodiment and a description thereof is omitted.

FIG. 8 is a plan view showing a portion of the periodic structure 10 according to the present embodiment. In the present embodiment, the dielectric constant of the insulating layer 60 is 4.4 and the dielectric dissipation factor thereof is 0.018. As shown in FIG. 8, the conductor patch 41 has a shape extended in one direction in the present embodiment, the flat shape thereof is quadrangular, and the four angles are each 90 degrees. In the present embodiment, the unit element 12 includes four conductor patch groups 100, 101, 102, and 103. The unit element 12 is shown inside a range F81 indicated by a double-dashed chain line. Moreover, instead of the first and second LC resonance circuits 90 and 91, different LC resonance circuits are formed.

First, the four conductor patch groups 100 to 103 will be described. Each of the four conductor patch groups 100 to 103 includes the four conductor patches 41 and is configured by the two conductor patches 41 being assembled side by side in the x-axis x and y axis directions respectively.

The conductor patches 41 in each conductor patch group have one set of two sides opposite to each other of circumferences parallel to the x axis direction and the other set of two sides opposite to each other parallel to the y axis direction. A posture of the conductor patch 41 whose longer direction is along the x axis direction is defined as a first posture P1. A posture of the conductor patch 41 whose shorter direction is along the x axis direction is defined as a second posture P2.

In each conductor patch group, the conductor patches 41 are arranged so that the first and second postures P1 and P2 are alternated and a gap is defined between the conductor patches 41 adjacent to each other. With the arrangement described above, each of the conductor patch groups 100 to 103 becomes quadrangular by the four conductor patches 41 being assembled.

Then, the conductor patch groups 100 to 103 are set in such a way that arrangement of the conductor patches 41 is symmetric with respect to the y axis direction for the conductor patch groups adjacent to each other in the x axis direction and arrangement of the conductor patches 41 is symmetric with respect to the x axis direction for the conductor patch groups adjacent to each other in the y axis direction. Thus, if the unit element 12 is rotated by 90 degrees and moved in the x axis direction for a half period, the same shape as that before the rotation can be obtained.

Moreover, sides along the x axis direction in circumferences of the conductor patch groups adjacent to each other in the x axis direction (in the present embodiment, the conductor patch groups 100 and 101 and the conductor patch groups 102 and 103) are mutually on the same lines and parallel to the x axis direction. Similarly, sides along the y axis direction in circumferences of the conductor patch groups adjacent to each other in the y axis direction (in the present embodiment, the conductor patch groups 100 and 103 and the conductor patch groups 101 and 104) are mutually on the same lines and parallel to the y axis direction.

In the present embodiment, the conductor patches 41 arranged in circumferences inside the unit element 12 are arranged in the order of the second posture P2, the first posture P1, the first posture P1, and the second posture P2 along the x axis direction. The conductor patches 41 are arranged in the order of the second posture P2, the first posture P1, the first posture P1, and the second posture P2 along the y axis direction.

The via 71 described in the second embodiment is provided at an inside end facing the center of each semiconductor patch group in each of the conductor patches 41 constituting each semiconductor patch group. The via 71 is used in place of the plate-type connecting conductor 70. The via 71 mutually electrically connects each of the conductor patches 41 and the ground layer 50. The via 71 has the same structure as that described in the second embodiment.

With the configuration described above, an LC resonance circuit 94 constituted of the conductor patches 41 in the first posture P1 and extended in the x axis direction and an LC resonance circuit 95 constituted of the conductor patches 41 in the second posture P2 and extended in the y axis direction are alternately arranged in the x axis direction. In the y axis direction, the two first postures P1 alternate with the two second postures P2. In FIG. 8, the LC resonance circuit 94 extended in the x axis direction is shown by being enclosed with a double-dashed chain line F82. The LC resonance circuit 95 extended in the y axis direction is shown by being enclosed with a double-dashed chain line F83.

The LC resonance circuits 94 and 95 are configured also in the y axis direction. The LC resonance circuit 94 is shown on y axis direction within a range F86 indicated by a double-dashed chain line in FIG. 8. The LC resonance circuit 94 is extended in the y axis direction. The LC resonance circuit 95 is shown within a range F87. The LC resonance circuit 95 is shortened in the y axis direction. Thus, even if the incident wave I contains a linear polarization component in the y axis direction, the same operation and effect as those when the incident wave I contains a linear polarization component in the x axis direction can be obtained.

The interval of a gap 82 between the conductor patches 41 functioning as a capacitor in the LC resonance circuits 94 and 95 is set as g3. In the present embodiment, g3 is 1 mm. The length of the LC resonance circuit 94 along the x-axis x or y axis direction is set as x3. In the present embodiment, x3 is 40 mm. The interval between the LC resonance circuits 94 and 95 is set as g4. In the present embodiment, g4 is 1 mm. The interval of the LC resonance circuit 95 along the x-axis x or y axis direction is set as x4. In the present embodiment, x4 is 28 mm.

The state of a neighborhood of the conductor patch 41 extended in the x axis direction a portion of which is cut out and viewed in perspective is shown in a range F84 enclosed with a double-dashed chain line. As shown in F84, the distance from the surface 11 (surface 42) of the periodic structure 10 to the surface of the ground layer 50 opposite to the insulating layer 60 is set as h3. h3 is, like in the third embodiment, 6.4 mm.

Two types of LC resonance circuits are provided in the periodic structure 10 configured as described above by including the LC resonance circuits 94 and 95. The LC resonance circuit 94 is set to reflect the first reflected wave R1 and the LC resonance circuit 95 is set to reflect the second reflected wave R2. The phase difference between the first and second reflected waves R1 and R2 is 180 degrees. In this case, at least one of the first and second reflected waves R1 and R2 has a phase difference with regard to the incident wave in the range of −90 degrees or more and 90 degrees or less.

Each of the above dimensions is a value set so that the LC resonance circuits 94 and 95 reflect the first and second reflected waves R1 and R2 respectively. Thus, the reflected wave by the LC resonance circuit 94 and that by the LC resonance circuit 95 interfere, leading to a controlled reflected wave.

The LC resonance circuits 94 and 95 are configured also in the y axis direction. Thus, even if the incident wave I contains a linear polarization component in the y axis direction, the same operation and effect as those when the incident wave I contains a linear polarization component in the x axis direction can be obtained.

Thus, in the present embodiment, in addition to the effect of the first embodiment, the same operation and effect can be obtained even if the incident wave I contains a linear polarization component in the y axis direction.

FIG. 9 is similar to FIG. 7 used in the third embodiment and is a graph showing a simulation result of frequency characteristics of reflected power attenuation at a position 157 mm over the surface 11 (surface 42)(in the direction opposite to the direction toward the ground layer 50) of the periodic structure 10. The periodic structure 10 is designed so as to have an effect of controlling reflected waves when the frequency of the incident wave I is 953 MHz (an example of the specific frequency in the embodiment).

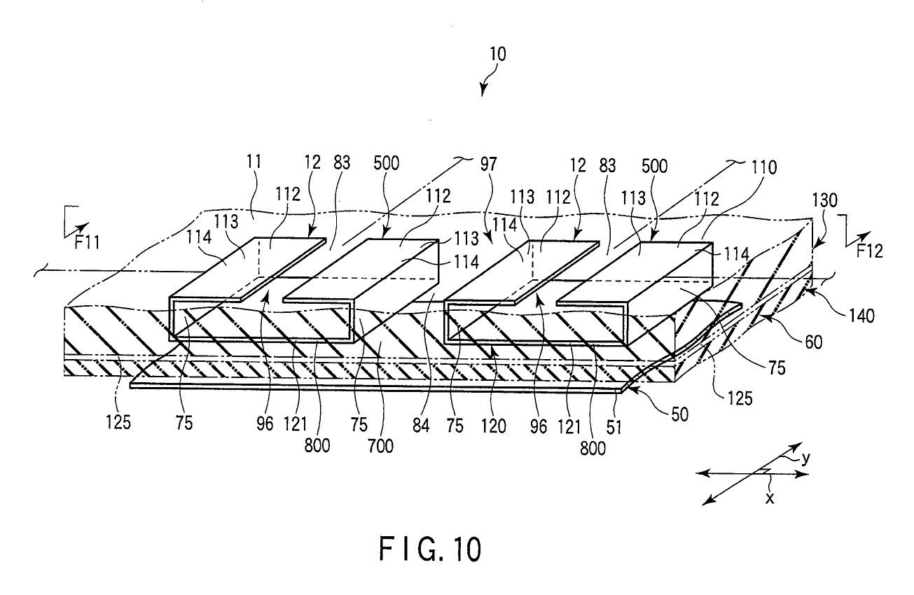

Next, the periodic structure according to the fifth embodiment will be described using FIGS. 10 to 12. The same reference numerals are attached to components having the similar functions as those in the first embodiment and a description thereof is omitted.

In the present embodiment, the structure of the periodic structure 10 is different from that in the first embodiment. In the present embodiment, the periodic structure 10 includes, instead of the patch layer 40, a first patch layer 110 and a second patch layer 120. Further, in place of the plate-type connecting conductor 70, a plate-type connecting conductor 75 that mutually electrically connects the first and second patch layers 110 and 120 is provided. Further, in place of the insulating layer 60, first and second insulating layers 130 and 140 are provided. The remaining structure may be the same as that in the first embodiment. The above different structure will be described.

FIG. 10 is a perspective view showing the periodic structure 10 by cutting out a portion thereof. As shown in FIG. 10, the first patch layer 110 is a portion of the surface 11 of the periodic structure 10. The first patch layer 110 includes a plurality of first conductor patches 112. Each of the first conductor patches 112 may have the same shape.

The first conductor patch 112 has a quadrangular flat shape and is extended in one direction. Four angles of the first conductor patch 112 are each 90 degrees. The first conductor patches 112 are spaced in the x-axis x and y axis directions so that the longer direction is parallel to the y axis direction and the shorter direction is parallel to the x axis direction. In this case, the side (edge) of the first conductor patch 112 in the longer side is parallel to the y axis direction and the side (edge) of the first conductor patch 112 in the shorter side is parallel to the x axis direction.

While the first conductor patches 112 are shown in FIG. 10 as a row (state of the four first conductor patches 112 being placed side by side) in the x axis direction, there is actually a plurality of rows and the first conductor patches 112 are arranged also in the y axis direction in a plurality of rows. In FIG. 10, the state of the first conductor patches 112 being placed side by side is omitted with a double-dashed chain line.

Rows (in FIG. 10, only one row is shown) of the first conductor patches 112 placed in the x axis direction are parallel to the x axis direction and keep a fixed distance to the first conductor patches 112 adjacent to each other in the y axis direction. Sides along the x axis direction in circumferences of the first conductor patches 112 in one row placed in the x axis direction are arranged on one straight line (parallel to the x axis direction).

Rows (in FIG. 10, only four rows are shown) of the first conductor patches 112 placed in the y axis direction are parallel to the y axis direction and keep a fixed distance to the first conductor patches 112 adjacent to each other in the x axis direction. Sides along the y axis direction in circumferences of the first conductor patches 112 in one row placed in the y axis direction are arranged on one straight line (parallel to the y axis direction).

The second patch layer 120 is provided between the first patch layer 110 and the ground layer 50. The second patch layer 120 includes a plurality of second conductor patches 121. Each of the second conductor patches 121 is the same. As shown in FIG. 10, the second conductor patch 121 has a quadrangular flat shape and each angle is 90 degrees. A pair of two sides opposite to each other in circumferences of the second conductor patches 121 is parallel to the x axis direction and the other pair of two sides opposite to each other is parallel to the y axis direction.

The second conductor patches 121 are arranged to overlap with a pair of the first conductor patches 112 adjacent to each other in the x axis direction in the lamination direction of the first and second patch layers 110 and 120 and has an overlapping size (the same size) in the lamination direction as the pair of the first conductor patches 112 adjacent to each other in the x axis direction. Further, circumferences of the second conductor patches 121 overlap with those of the first conductor patches 112 in the lamination direction. A gap 700 is defined between the second conductor patches 121.

The first conductor patch 112 and the second conductor patch 121 are mutually electrically connected by the plate-type connecting conductor 75. The plate-type connecting conductor 75 in the present embodiment has the same structure as that of the plate-type connecting conductor 70 described in the first embodiment and has a flat shape having a substantially fixed thickness and is made of metal. The connecting conductor 75 may have completely fixed thickness.

The plate-type connecting conductor 75 electrically connects an outside portion in the x axis direction of a contour portion 114 (like the contour portion 43 in the first embodiment) of a pair of the first conductor patches 112 adjacent to each other in the x axis direction and an edge along the y axis direction of the second conductor patch 121. The plate-type connecting conductor 75 extends from one end of the first and second conductor patches 112 and 121 to the other end thereof and is parallel to the y axis direction.

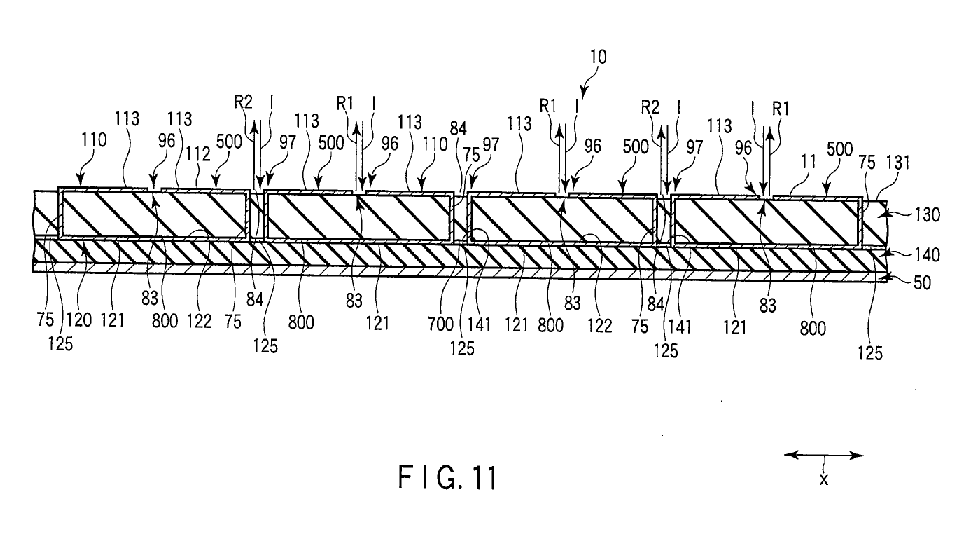

FIG. 11 is a sectional view of the periodic structure 10 along the F11-F11 line shown in FIG. 10. FIG. 11 shows a state in which the periodic structure 10 is cut along the x axis direction. As shown in FIG. 11, the first and second patch layers 110 and 120 and the plate-type connecting conductor 75 present a C shape as a side shape when viewed in the y axis direction.

As shown in FIG. 11, a first insulating layer 130 is provided between the first patch layer 110 and the second patch layer 120. The surface 11 of the periodic structure 10 is constituted of a surface 113 of the first conductor patches 112 of the first patch layer 110 and a surface 131 of the first insulating layer 130. The surface 113 of the first patch layer 110 and the surface 131 of the first insulating layer 130 are not flush and the first patch layer 110 is formed on the surface 131. This is because the periodic structure 10 is constituted of a printed board also in the present embodiment and the first patch layer 110 is formed by removing other portions than the first conductor patches 112 from a copper foil layer formed on the surface of the printed board.

A second insulating layer 140 is provided between the second patch layer 120 and the ground layer 50. The second insulating layer 140 is formed of a dielectric material.

The periodic structure 10 is formed of one double-sided board between the first patch layer 110 and the second patch layer 120. The double-sided board has a copper foil layer formed on both sides and an insulating layer formed therebetween. One copper foil layer becomes the first patch layer 110 and the other copper foil layer becomes the second patch layer 120. The insulating layer provided therebetween becomes the first insulating layer 130.

The second insulating layer 140 and the ground layer 50 are constituted of one one-sided board. The one-sided board has a copper foil layer formed on one side of an insulating layer. The copper foil layer becomes the ground layer 50 and the insulating layer becomes the second insulating layer 140. The periodic structure 10 is formed by overlapping and joining two boards formed as described above.

In this case, the second patch layer 120 is formed by removing other portions than the second conductor patches 120 from the copper foil layer and thus, a surface 122 of the second patch layer 120 and a surface 141 of the second insulating layer 140 are not flush.

As a result, a portion of the second patch layer 120 where the second conductor patch 121 is absent becomes an air layer 125. The air layer also functions as an insulator. Reflection characteristics of the periodic structure 10 hardly change depending on whether the air layer is present.

When the periodic structure 10 is constituted of two boards like the present embodiment, the first and second patch layers 110 and 120 can be formed by removing other portions than the first and second conductor patches 112 and 121 from a board having a copper foil layer formed on both sides thereof and thus, the first and second patch layers 110 and 120 can easily be adjusted. Moreover, the phase of reflected waves can easily be adjusted when a prototype is built.

In the present embodiment, as an example, the periodic structure 10 is constituted of two boards. However, the present embodiment is not limited to this. For example, a multiplayer board may be used as a printed board constituting the periodic structure 10. The second patch layer 120 is already formed inside the multiplayer board and thus, the air layer 125 is not formed between the second patch layer 120 and the second insulating layer 140.

If the periodic structure 10 is constituted of a multiplayer board, the assembly work of the periodic structure 10 becomes easier.

In FIG. 10, the first and second insulating layers 130 and 140 are omitted with a double-dashed chain line to make the first and second first conductor patches 112 and 121 and the plate-type connecting conductor 75 easier to understand.

With a pair of the first conductor patches 112 adjacent to each other in the x axis direction and the second conductor patch 121 being electrically connected by the plate-type connecting conductor 75 as described above, the pair of the first conductor patches 112 is electrically connected by the direct current via the plate-type connecting conductor 75 and the second conductor patch 121. A pair of the first conductor patches 112 electrically connected to the common second conductor patch 121 via a connecting conductor (in the present embodiment, the plate-type connecting conductor 75) constitutes a conductor patch unit 500.

The conductor patch unit 500 is an example of the conductor patch unit in the present embodiment and also an example of a combination in the present embodiment. In other words, in the present embodiment, the conductor patch unit includes a combination of the first conductor patches 112 adjacent to each other and thus, the combination is the same as that in the conductor patch unit.

With this structure, an LC resonance circuit 96 in which a gap 83 between the first conductor patches 112 connected by the plate-type connecting conductors 75 function as a capacitor and a current path 800 by the plate-type connecting conductor 75 and the second conductor patch 121 functions as a coil is formed. The gap 83 is an example of a first gap in the present embodiment.

The LC resonance circuit 96 constituted of a pair of the first conductor patches 112, one second conductor patch 121, and the plate-type connecting conductors 75 connecting these patches as described above may all have a similar structure. The interval of the gap 83 of the LC resonance circuit 96 may be the same in all the LC resonance circuits 96. Since the plate-type connecting conductor 75 functions as a wall like in the first embodiment, the LC resonance circuit 96 is not affected by incident waves entering gaps of other LC resonance circuits. Thus, like the first embodiment, reflected waves reflected by one LC resonance circuit 96 is constituted of the incident wave I entering the gap 83 of the relevant LC resonance circuits 96.

In the present embodiment, the unit element 12 is constituted of a pair of the first conductor patches 112 and the plate-type connecting conductor 75 that connects the pair of the first conductor patches 112 to the second conductor patch 121.

As shown in FIG. 11, an LC resonance circuit 97 is defined between the LC resonance circuits 96 adjacent to each other in the x axis direction. The LC resonance circuit 97 will be described. In the LC resonance circuit 97, a gap 84 between the first conductor patches 112, among the first conductor patches 112 adjacent to each other in the x axis direction, that are not mutually electrically connected by the plate-type connecting conductor 75 and the second conductor patch 121 functions as a capacitor. The gap 84 is an example of a second gap in the present embodiment. Further, in the LC resonance circuit 97, a current path functioning as a coil is configured by the first and second insulating layers 130 and 140 and the ground layer 50 by using the insulating layers 130 and 140 as a portion of the current path. The interval of the gap 84 may be uniform. Thus, the width of the gap 700 between the second conductor patches 121 is the same as that of the gap 84.

The LC resonance circuit 97 does not include a connecting conductor functioning as a wall and thus is affected by the incident wave I entering the other gaps 84. In other words, phase shifts of reflected waves reflected by the LC resonance circuit 97 are affected by surroundings.

Therefore, by setting different phase differences for reflected waves reflected by the LC resonance circuits 96 and 97 with regard to the incident wave I, the periodic structure 10 can reflect two reflected waves having mutually different phases. That is, two types of LC resonance circuits are formed. In the present embodiment, the first reflected wave R1 is reflected by the LC resonance circuit 96 and the second reflected wave R2 is reflected by the LC resonance circuit 97.

The phase of the first reflected wave R1 and that of the second reflected wave R2 are mutually different. The reflection phase of the first reflected wave R1 is affected by the gap 83. The reflection phase of the second reflected wave R2 is affected by the gap 84. The periodic structure 10 is configured so that the phase difference between the first and second reflected waves R1 and R2 becomes a desired value by adjusting the shape (width) of the gaps 83 and 84 by trial and error.

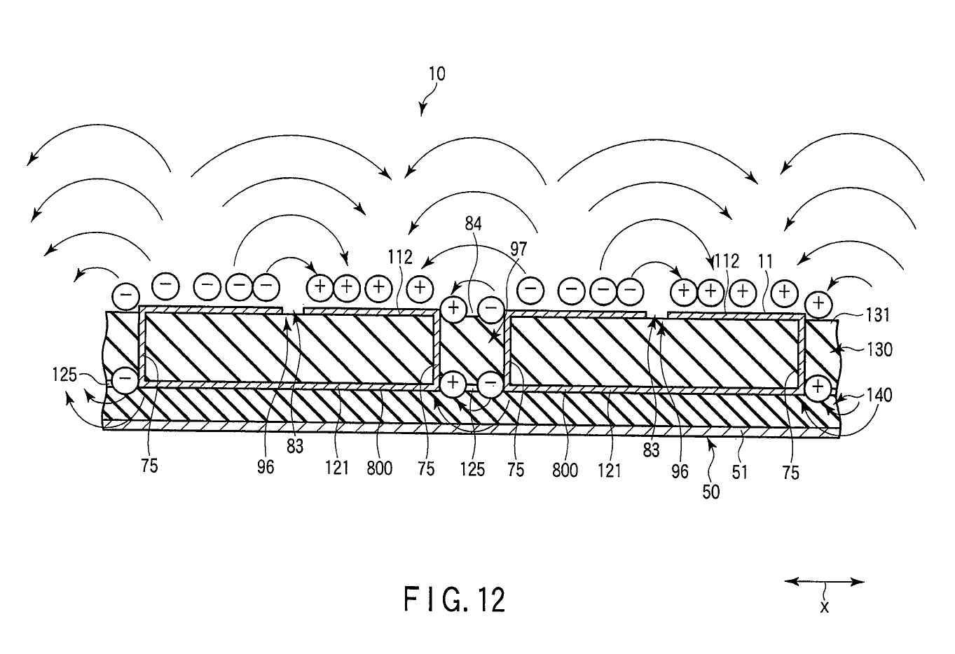

FIG. 12 is a schematic diagram showing a charge distribution and electric lines of force (electric field) at some instant when the incident wave I enters the periodic structure 10. As shown in FIG. 12, one side (in the present embodiment, the right side in FIG. 12) of the gap 83 of the LC resonance circuit 96 is positively charged and the other side (in the present embodiment, the left side in FIG. 12) is negatively charged.

In the LC resonance circuit 97, one side (in the present embodiment, the right side) of the gap 84 is negatively charged and the other side (in the present embodiment, the left side) is positively charged.

With positively and negatively charged positions of the gaps 83 and 84 interchanged in the x axis direction as described above, the phase of the first reflected wave R1 reflected by the LC resonance circuit 96 and that of the second reflected wave R2 reflected by the LC resonance circuit 97 are shifted by 180 degrees. That is, the phase difference between the first and second reflected waves R1 and R2 reflected by the LC resonance circuits 96 and 97 becomes 180 degrees. Thus, the first and second reflected waves R1 and R2 from the LC resonance circuits 96 and 97 cancel out each other so that reflected waves reflected by the periodic structure 10 are controlled.

Reflection phases of electromagnetic waves reflected by the LC resonance circuits 96 and 97 are adjusted by adjusting the structure of the LC resonance circuits 96 and 97. More specifically, the structure includes intervals of the gaps 83 and 84, intervals of the first and second patch layers 110 and 120, shapes (including sizes) of the first and second first conductor patches 112 and 121, and the interval between the second patch layer 120 and the ground layer 50.

Even in the present embodiment, the same effect as that in the first embodiment can be obtained.

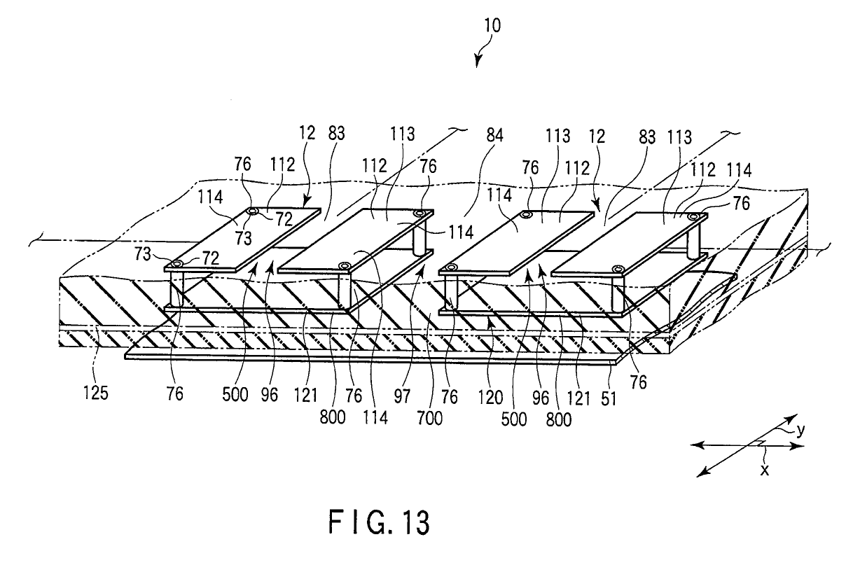

Next, the periodic structure according to the sixth embodiment will be described using FIG. 13. The same reference numerals are attached to components having the similar functions as those in the fifth embodiment and a description thereof is omitted. In the present embodiment, the connecting conductor is different from that in the fifth embodiment. The remaining structure may be the same as that in the fifth embodiment. The above different structure will be described.

FIG. 13 is a perspective view showing the periodic structure 10 according to the present embodiment by cutting out a portion thereof. In the present embodiment, as shown in FIG. 13, a via 76 described in the second embodiment is used as the connecting conductor. The via 76 has the same structure as that of the via 71 in the second embodiment. The via 76 is arranged in an outside corner of the contour portion 114 of a pair of the first conductor patches 112 constituting the LC resonance circuit 96. The via 76 electrically connects the first conductor patches 112 and the second conductor patch 121.

The present embodiment can obtain the same operation and effect as those in the fifth embodiment.

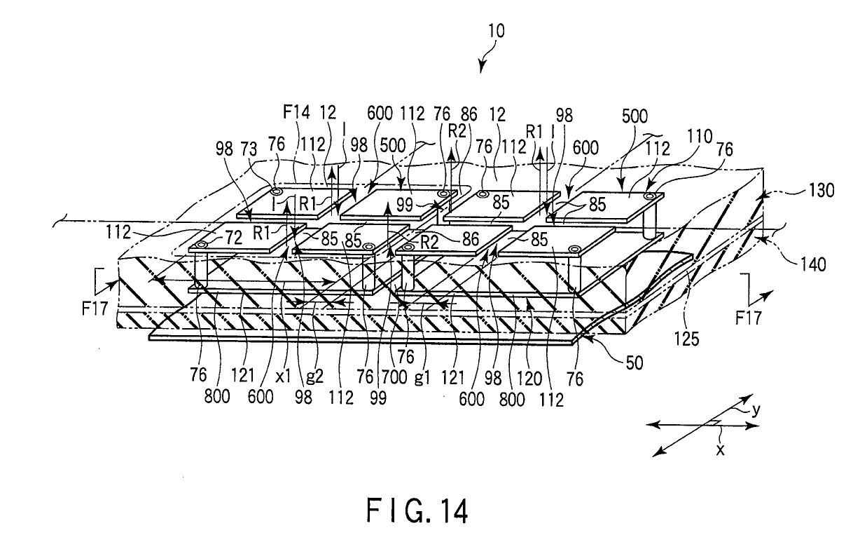

Next, the periodic structure according to the seventh embodiment will be described using FIG. 14. The same reference numerals are attached to components having the similar functions as those in the fifth embodiment and a description thereof is omitted. In the present embodiment, the first conductor patch 112 and the connecting conductor are different from those in the fifth embodiment. The remaining structure may be the same as that in the fifth embodiment. The above different structure will be described.

FIG. 14 is a perspective view showing the periodic structure 10 by cutting out a portion thereof. As shown in FIG. 14, the unit element 12 of the periodic structure 10 includes four first conductor patches 112 and one second conductor patch 121. In FIG. 14, the unit element 12 is shown inside a range F14 indicated by a double-dashed chain line.

All of the first conductor patches 112 are the same and the flat shape thereof is, as an example, square. A set of two sides opposite to each other in circumferences of the first conductor patches 112 is parallel to the x axis direction and the other set of sides opposite to each other is parallel to the y axis direction. Sides along the x axis direction in circumferences of the first conductor patches 112 in one row placed in the x axis direction are arranged mutually on one straight line (parallel to the x axis direction). Similarly, sides along the y axis direction in circumferences of the first conductor patches 112 in one row placed in the y axis direction are arranged mutually on one straight line (parallel to the y axis direction).

The four first conductor patches 112 constituting the unit element 12 are arranged in the x-axis x and y axis directions, two by two, and adjacent to each other. In FIG. 14, the first and second insulating layers 130 and 140 are omitted with a double-dashed chain line. Intervals of gaps defined in the x-axis x and y axis directions between the four first conductor patches 112 constituting the unit element 12 are the same.

The flat shape of the second conductor patch 121 is square and each angle thereof is 90 degrees. A set of two sides opposite to each other in circumferences of the second conductor patch 121 is parallel to the x axis direction and the other set of two sides is parallel to the y axis direction.

The second conductor patch 121 is overlapped with the four first conductor patches 112 constituting the unit element 12 in the lamination direction of the first and second patch layers 110 and 120. Further, circumferences of the second conductor patch 121 are overlapped with those of the four first conductor patches 112 constituting the unit element 12 in the lamination direction.

In the present embodiment, the via 76 used in the fifth embodiment is used as the connecting conductor. One via 76 as the connecting conductor is provided in the first conductor patch 112 and arranged in each corner of the four first conductor patches 112 constituting the unit element 12. The via 76 electrically connects to four corners of the second conductor patch 121. The second conductor patch 121 is an example of a common second conductor in the present embodiment.

In the present embodiment, the first conductor patches 112 of the four first conductor patches 112 constituting the unit element 12 adjacent to each other in the x axis direction constitute combinations 600 and these combinations 600 are adjacent to each other in the y axis direction to constitute the conductor patch unit 500.

In the present embodiment, an LC resonance circuit 98 having a gap 85 defined in the x-axis x and y axis directions of the first conductor patches 112 inside the unit element 12 and an LC resonance circuit 99 having a gap 86 defined between the unit elements 12 in the x-axis x and y axis directions are provided.

The width of the gap 700 between the second conductor patches 121 is the same as that of the gap 86. Intervals of all the gaps 85 are the same. Intervals of all the gaps 86 are the same. Intervals of all the gaps 700 are the same. The LC resonance circuit 98 reflects the first reflected wave R1. The LC resonance circuit 99 reflects the second reflected wave R2.

The LC resonance circuits 98 and 99 are placed alternately in the x axis direction and also alternately in the y axis direction. Thus, even if the incident wave I contains a linear polarization component along the y axis direction, reflected waves are controlled. Thus, in the present embodiment, not only the same operation and effect as those in the fifth embodiment is obtained, but also reflected waves can be controlled even if the incident wave contains a linear polarization component along the y axis direction.

The present embodiment has a structure in which two types of LC resonance circuits (LC resonance circuits 98 and 99) whose reflection phases are mutually different with regard to the incident wave are provided inside the unit element 12. When a structure in which a plurality of types of LC resonance circuits whose reflection phases are mutually different with regard to the incident wave are provided inside the unit element 12 is adopted, that is, there is locally a plurality of gaps inside the unit element 12 that emit strong reflected waves whose reflection phases with regard to the incident wave are mutually different, a reflected wave is defined as a vector represented by the absolute value of the electric field strength and the phase of a polarization direction component of the incident wave and the structure and dimensions of the LC resonance circuit of each gap are adjusted so that the absolute value of a vector obtained by totaling each reflected wave vector is equal to a fixed value or less (for example, 1/\sqrt{2} of simple addition of the absolute value of each reflected wave vector or less). By making such adjustments, reflected waves can be controlled.

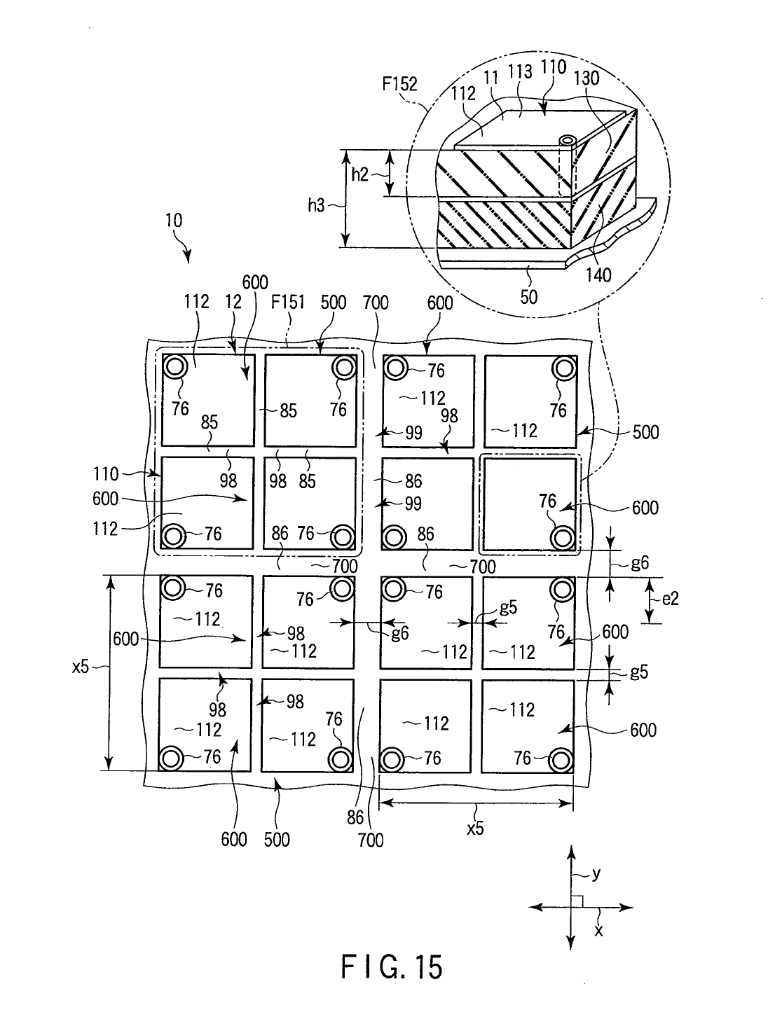

Next, the periodic structure according to the eighth embodiment will be described using FIGS. 15 to 18. The same reference numerals are attached to components having the similar functions as those in the seventh embodiment and a description thereof is omitted. In the present embodiment, the structure of the periodic structure 10 is the same as that in the seventh embodiment. In the present embodiment, each dimension of the periodic structure 10 is set to a predetermined value.

FIG. 15 is a plan view showing a portion of the periodic structure 10. In FIG. 15, one unit element 12 is shown within a range F151 indicated by a double-dashed chain line. The width of the unit element 12 along the x-axis x and y axis directions is set as x5. In the present embodiment, x5 is 38 mm. The gap 85 is defined between the first conductor patches 112 adjacent to each other in the x-axis x and y axis directions inside the unit element 12. The interval of the gap 85 is g5. In the present embodiment, g5 is 0.5 mm. The interval of the gap 86 between the unit elements 12 adjacent to each other in the x-axis x and y axis directions is g6. In the present embodiment, g6 is 1 mm.

In FIG. 15, a state when viewed in perspective by cutting out surroundings of one first conductor patch 112 is shown inside a range F152 indicated by a double-dashed chain line. As shown inside the range F152, the distance from the surface 11 (in the present embodiment, the surface 113) of the periodic structure 10 to the surface in the second patch layer 120 opposite to the first insulating layer 130 is set as h2 and the distance from the surface 11 to the surface in the ground layer 50 opposite to the second insulating layer 140 as h3. In the present embodiment, h2=1.6 mm and h3=6.4 mm are set.

In the present embodiment, the dielectric constant of the first and second insulating layers 130 and 140 is 4.4 and the dielectric dissipation factor thereof is 0.018.

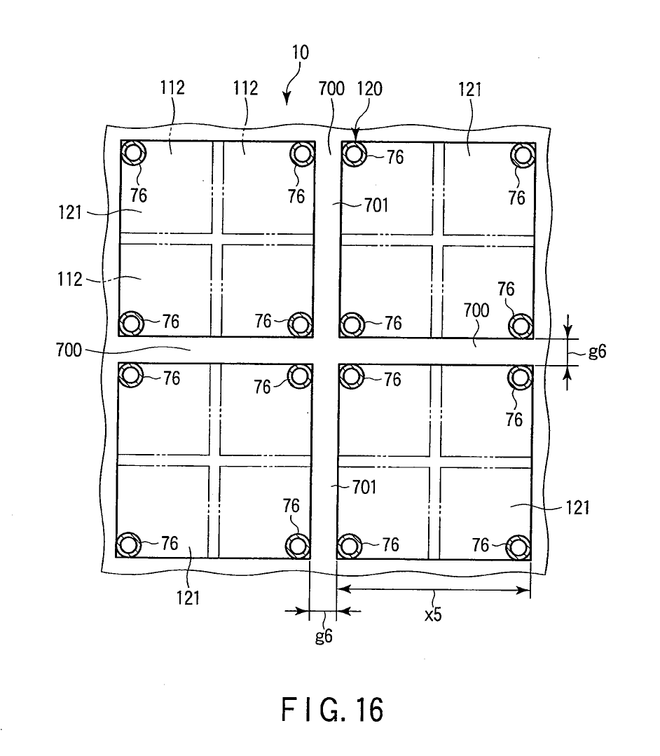

FIG. 16 is a sectional view showing a state in which the periodic structure 10 is cut between the first and second patch layers 110 and 120. FIG. 16 shows a portion of the second patch layer 120. In FIG. 16, the first conductor patches 112 overlapping in the lamination direction of the first and second patch layers 110 and 120 are indicated by a double-dashed chain line. As shown in FIG. 16, the second conductor patch 121 is overlapped with the four first conductor patches 112 constituting the unit element 12 in the lamination direction. Further, circumferences of the second conductor patch 121 are overlapped with those of the four first conductor patches 112 constituting the unit element 12 in the lamination direction.

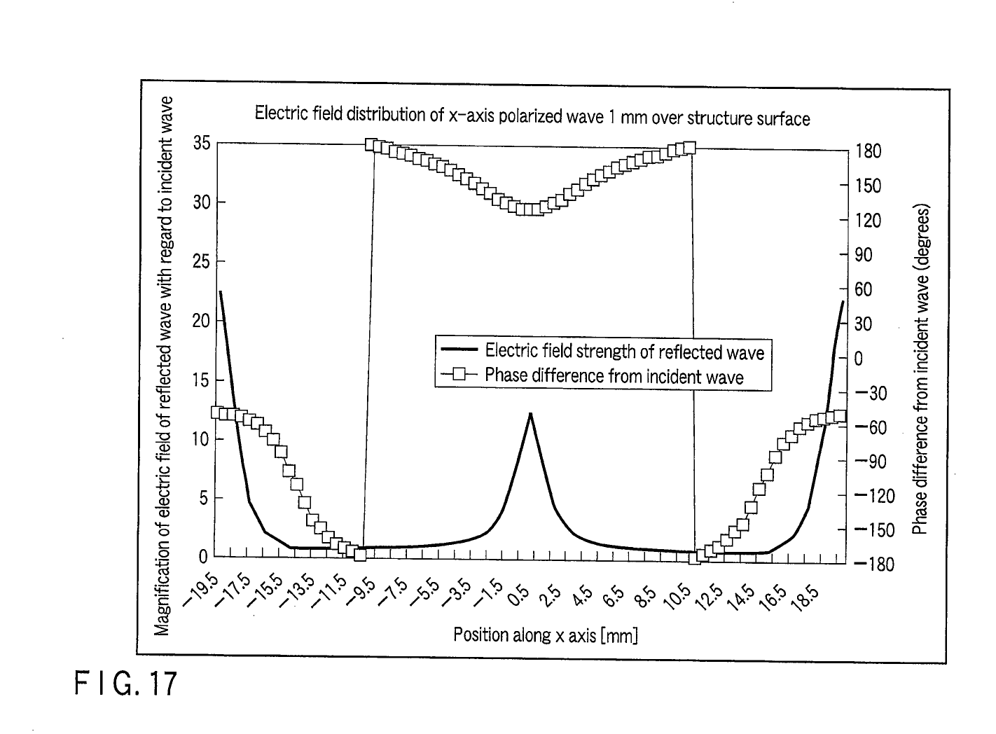

FIG. 17 is a graph showing a simulation result of an x-axis component of an electric field at a position 1 mm over the surface 11 (in the present embodiment, the surface 113) (in the direction opposite to the direction toward the ground layer 50) of the periodic structure 10 and, as shown in FIG. 15, a distance e2 from the end of the first conductor patch 112 in the y axis direction defining the end of the periodic structure 10 in the y axis direction. In the present embodiment, e2=9.5 mm is set.

In FIG. 17, the horizontal axis is similar to that in FIG. 6 used in the second embodiment and shows the position along the x axis direction. The position where the horizontal axis indicates 0 is the center of the unit element 12 along the x axis direction. In the present embodiment, the graph is shown with positive values on the right side of FIG. 17 and negative values on the left side. The vertical axis in FIG. 17 is similar to that in FIG. 6 and shows the magnification of an electric field of the component along the x axis direction of a reflected wave with regard to an incident wave at a position 1 mm over the surface 11.

Also in FIG. 17, like FIG. 6, the phase difference of one (electric field of the gap 86) of representative values of reflection characteristics of the periodic structure 10 with regard to the incident wave is a value of −90 degrees or more and 90 degrees or less.

As shown in FIG. 17, the phase difference of a reflected wave by the gap 85 inside the unit element 12 with regard to the incident wave I is about 120 degrees. The phase difference of a reflected wave reflected by the gap 86 between the unit elements 12 with regard to the incident wave I is about −60 degrees. As a result, the phase difference between reflected waves reflected by the gaps 85 and 86 adjacent to each other in the periodic structure 10 becomes about 180 degrees so that reflected waves cancel out each other.

Moreover, as shown in FIG. 17, a strong electric field is generated in the vicinity of each of the gaps 85 and 86 and thus, the electric field of each of the gaps 85 and 86 can be considered as a representative value of reflection characteristics of the periodic structure 10. Thus, by providing a phase difference so that electric fields of the gaps 85 and 86 cancel out each other to the gaps 85 and 86, reflected waves can be controlled.

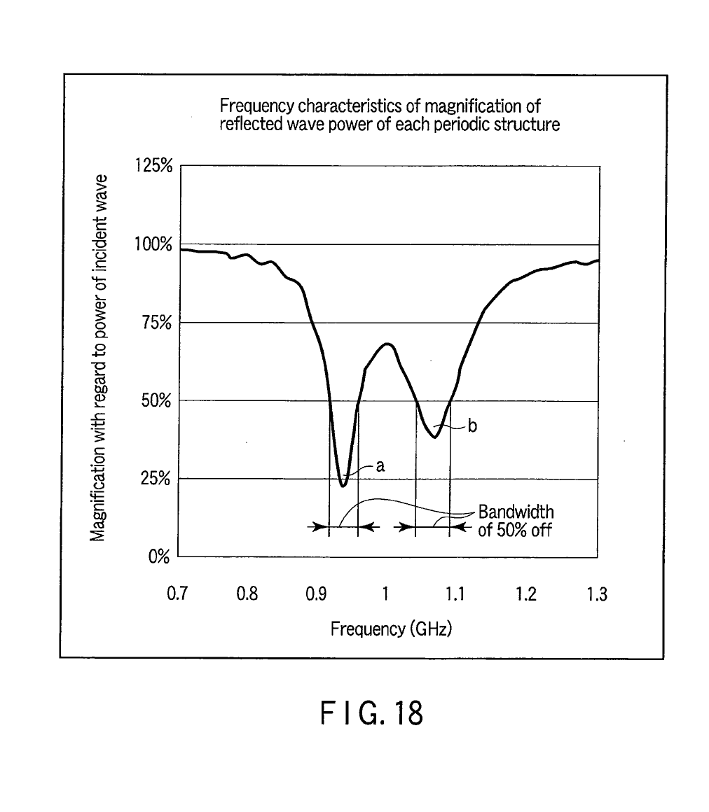

FIG. 18 is similar to FIG. 7 used in the third embodiment and is a simulation result of frequency characteristics of reflected power attenuation at a position 157 mm over the surface 11 (in the direction opposite to the direction toward the ground layer 50) of the periodic structure 10. The horizontal axis in FIG. 18 shows the frequency. The vertical axis in FIG. 18 shows the magnification of reflection with regard to electric power of an incident wave. As shown in FIG. 18, it is evident that the magnification is small near 953 MHz.

Incidentally, the periodic structure 10 according to the present embodiment is intended to have an effect of controlling reflected waves when the frequency of the incident wave I is 953 MHz (an example of the specific frequency in the present embodiment).

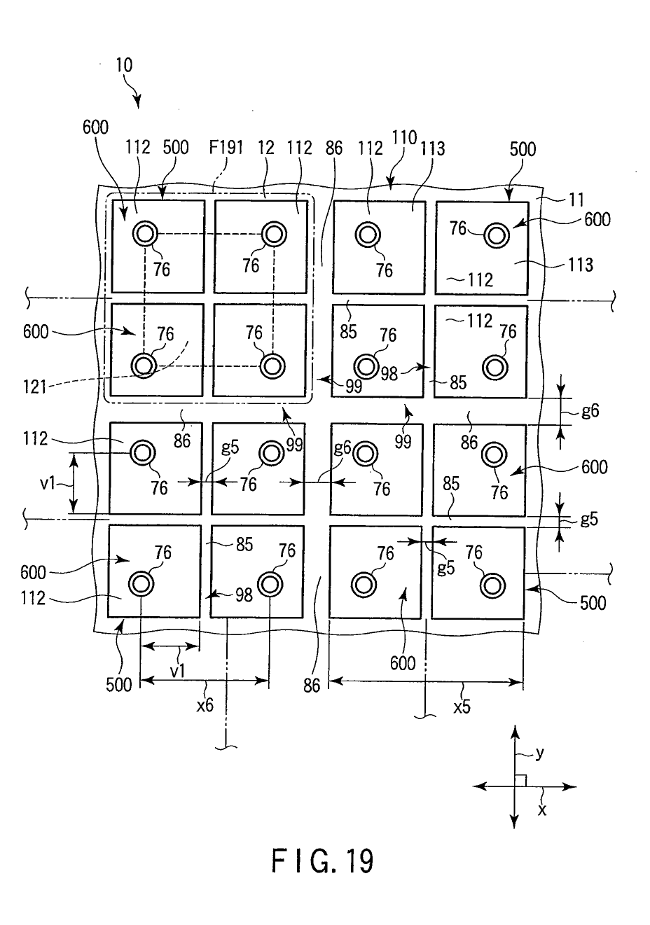

Next, the periodic structure according to the ninth embodiment will be described using FIGS. 19 to 21. The same reference numerals are attached to components having the similar functions as those in the eighth embodiment and a description thereof is omitted. In the present embodiment, the shape of the second conductor patch 121 and the arrangement of the via 76 are different from those in the eighth embodiment. Moreover, each dimension is different from that in the eighth embodiment. The remaining structure may be the same as that in the eighth embodiment. The above different structure will be described.

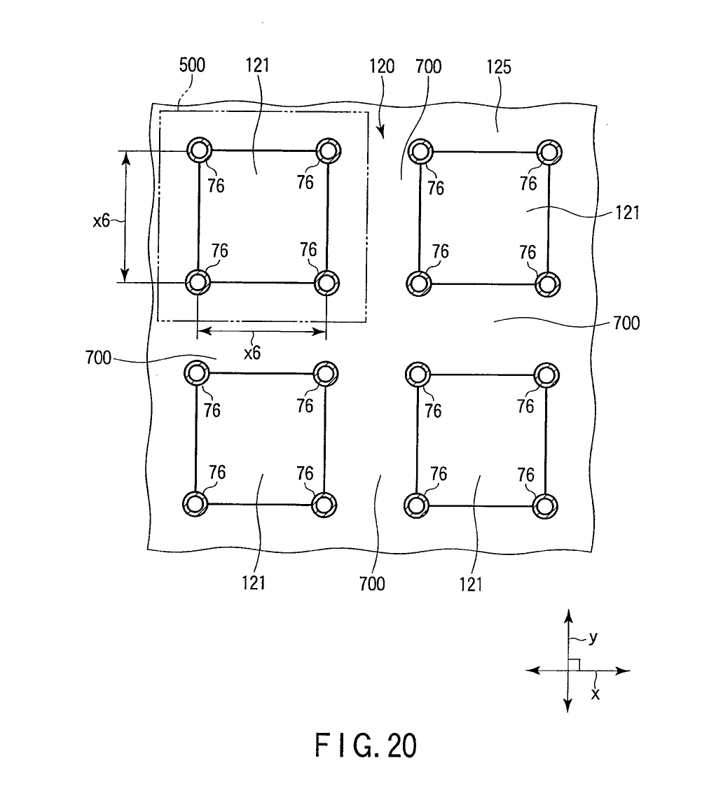

FIG. 19 is a plan view showing a portion of the surface 11 of the periodic structure 10. FIG. 20 is a sectional view of the periodic structure 10 showing a portion of the second patch layer 120. Like FIG. 16 of the eighth embodiment, FIG. 20 cuts between the first and second patch layers 110 and 120.

In FIG. 19, as an example, the second conductor patch 121 is indicated by a dotted line inside one unit element 12. In FIG. 20, outer edges of the four first conductor patches 112 constituting the unit element 12 are indicated by a double-dashed chain line. In the present embodiment, the width x5 of the periodic structure 10 along the x-axis x and y axis directions is 44 mm. The interval g5 of the gap 85 defined in the x-axis x and y axis directions inside the unit element 12 is 0.5 mm.

The interval g6 of the gap 86 defined in the x-axis x and y axis directions between the unit elements 12 is 1 mm. The length h2 from the surface 11 (surface 113) of the periodic structure 10 to the second patch layer 120 is 1.6 mm. The length h3 from the surface 11 to the ground layer 50 is 6.4 mm. In the present embodiment, the dielectric constant is 4.4 and the dielectric dissipation factor is 0.018.

In the present embodiment, as shown in FIG. 19, the via 76 is arranged on the inner side from circumferences of the first conductor patches 112. The first conductor patch 112 is square. The distance from a portion in edges of the first conductor patch 112 constituting the unit element 12 that specifies the gap 85 to the center of the via 76 in the x axis direction is set as v1. The distance from a portion in edges of the first conductor patch 112 constituting the unit element 12 that specifies the gap 85 to the center of the via 76 in the y axis direction is set as v1. In the present embodiment, v1 is 14.5 mm.

Thus, with the via 76 being arranged inside circumferences of the first conductor patches 112, as described above, adjustments to obtain the desired phase of a reflected wave can more easily be made when the periodic structure 10 is formed of two boards. That is, when the first patch layer 110 is formed by cutting away a copper foil layer formed on the surface of a board, the copper foil layer is further cut away to adjust the gaps 85 and 86 to obtain the desired phase of a reflected wave. In this case, with the via 76 being positioned inside circumferences of the first conductor patches 112, the presence of the via 76 will not prevent adjustments of the gaps 85 and 86 from being made.

As shown in FIG. 20, the flat shape of the second conductor patch 121 is substantially square. A set of two sides opposite to each other in circumferences of the second conductor patch 121 is parallel to the x axis direction and the other set of two sides opposite to each other is parallel to the y axis direction. Four corners of the second conductor patch 121 match centers of the vias 76. In other words, if the vias 76 provided in four corners are removed, the second conductor patch 121 becomes square. The via 76 is electrically connected to the four corners of the second conductor patch 121. If the width of the second conductor patch 121 along the x-axis x and y axis directions is set as x6, x6 is 29.5 mm in the present embodiment. x6 is also the distance between the centers of the vias 76 adjacent to each other by sandwiching the gap 85 of the unit element 12 therebetween. In the present embodiment, the width of the gap 700 between the second conductor patches 121 is different from that of the gap 86.

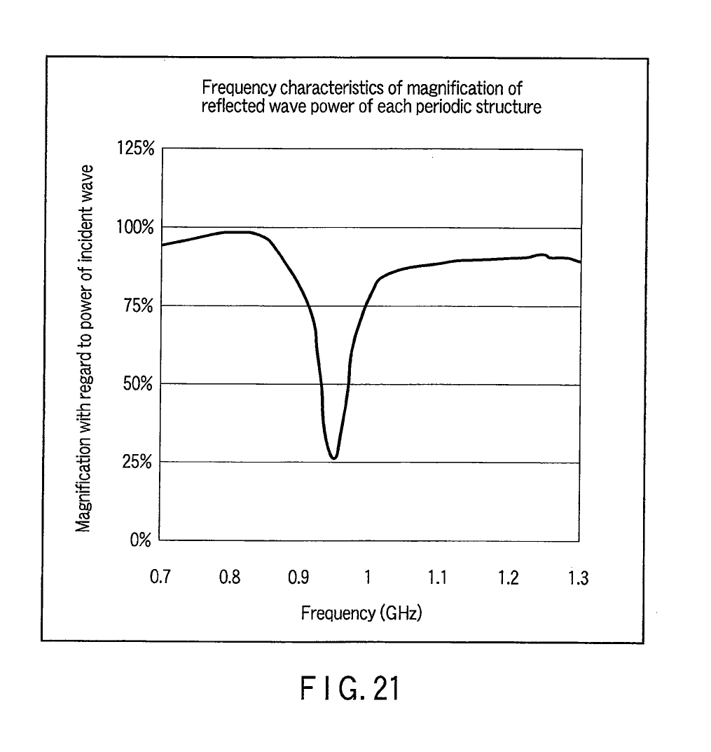

FIG. 21 is similar to FIG. 7 used in the third embodiment and is a graph showing a simulation result of frequency characteristics of reflected power attenuation at a position 157 mm over the surface 11 (surface 113)(in the direction opposite to the direction toward the ground layer 50) of the periodic structure 10. The horizontal axis shows the frequency of the incident wave I. The vertical axis shows the magnification of electric power of a reflected wave with regard to the electric power of the incident wave.

In the present embodiment, the periodic structure 10 is configured for the purpose of controlling reflected waves when the frequency of the incident wave I is 953 MHz (an example of the specific frequency in the present embodiment).

In the present embodiment, the same operation and effect as those in the eighth embodiment can be obtained.

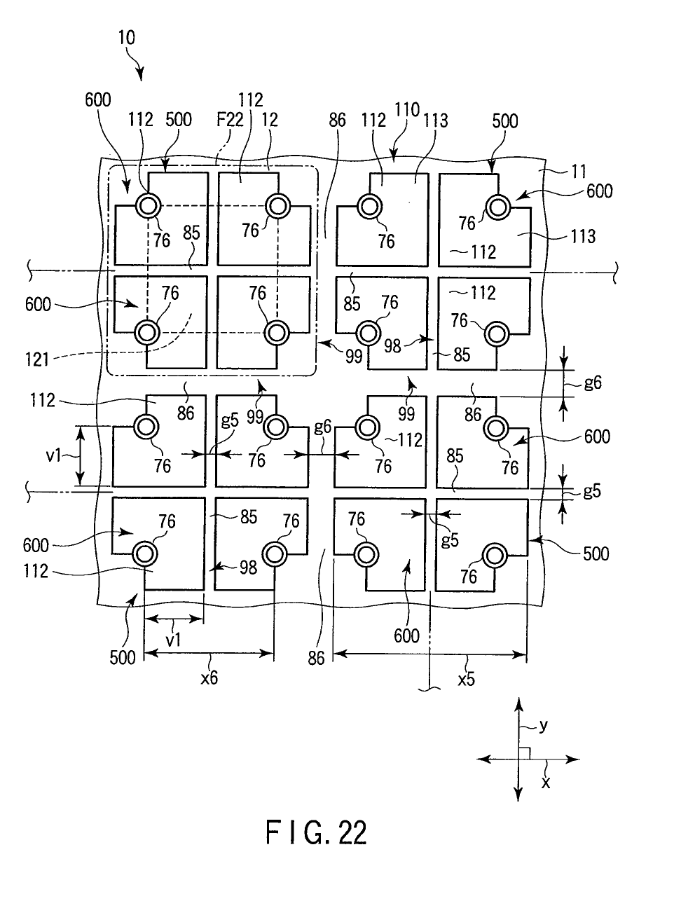

Next, the periodic structure according to the tenth embodiment will be described using FIGS. 22 to 24. The same reference numerals are attached to components having the similar functions as those in the ninth embodiment and a description thereof is omitted. In the present embodiment, the first conductor patch 112 is different from that in the ninth embodiment. The remaining structure may be the same as that in the ninth embodiment. The above different structure will be described.

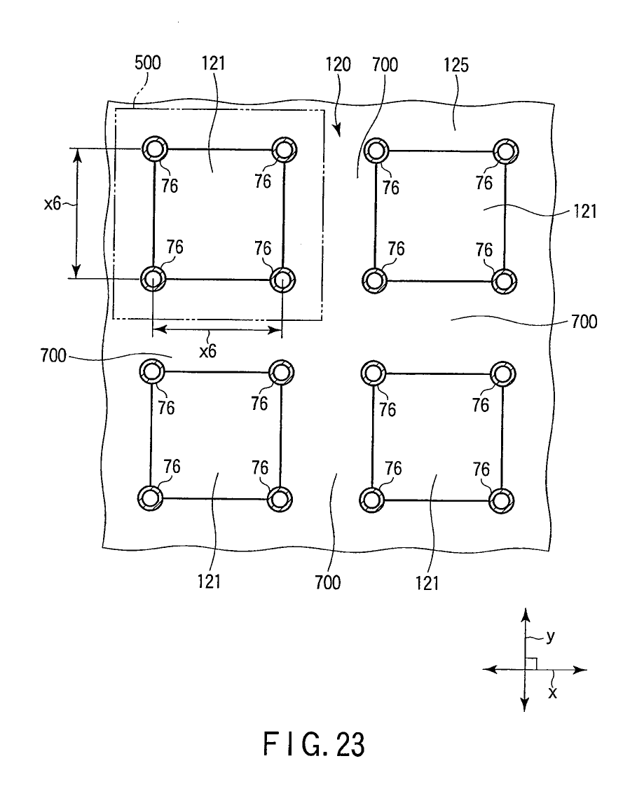

FIG. 22 is a plan view showing a portion of the surface 11 of the periodic structure 10. FIG. 23 is a sectional view showing a state in which the periodic structure 10 is cut between the first patch layer 110 and the second patch layer 120. FIG. 23 shows the second patch layer 120. The second patch layer 120 has the same structure as that in the ninth embodiment and is square. In the present embodiment, as shown in FIG. 22, the four first conductor patches 112 constituting the unit element 12 are cut out up to the via 76 in regions corresponding to the four corners of the unit element 12. The unit element 12 is shown inside a range F22 indicated by a double-dashed chain line. The four corners are ranges in each of the conductor patches 112 reaching the center of the conductor patch 112 along the x-axis x and y axis directions. The structure of the first conductor patch 112 constituting the unit element 12 may be the same as that in the ninth embodiment excluding the above different point from the ninth embodiment.

In the present embodiment, the width x5 of the unit element 12 along the x-axis x and y axis directions is 48 mm. The width x6 of the second conductor patch along the x-axis x and y axis directions is 33.5 mm. v1 is 16.5 mm.

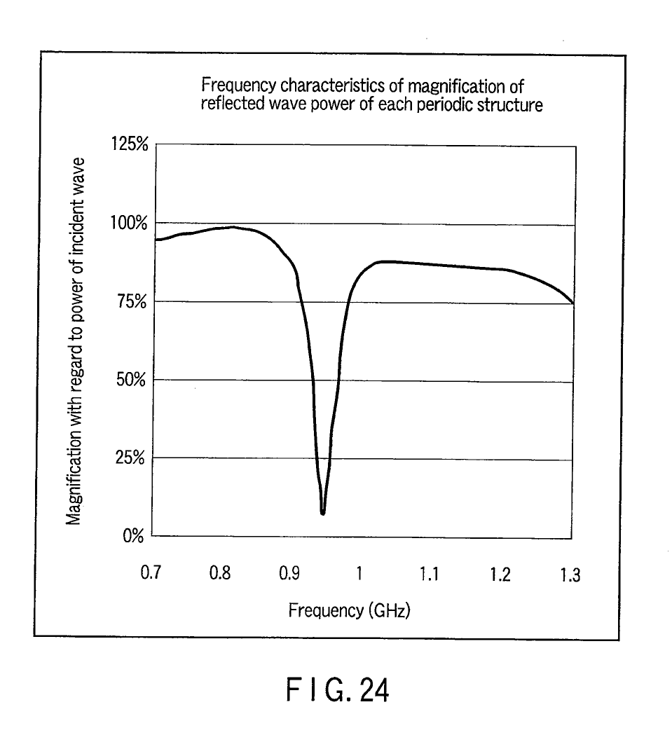

FIG. 24 is similar to FIG. 7 used in the third embodiment and is a graph showing a simulation result of frequency characteristics of reflected power attenuation at a position 157 mm over the surface 11 (in the direction opposite to the direction toward the ground layer 50) of the periodic structure 10. The horizontal axis in FIG. 24 shows the frequency of the incident wave I. The vertical axis in FIG. 24 shows the magnification of reflection electric power with regard to the electric power of the incident wave.

The periodic structure 10 according to the present embodiment is configured for the purpose of being able to control reflected waves when the frequency of the incident wave I is 953 MHz (an example of the specific frequency in the present embodiment).

In the present embodiment, the same operation and effect as those in the ninth embodiment can be obtained.

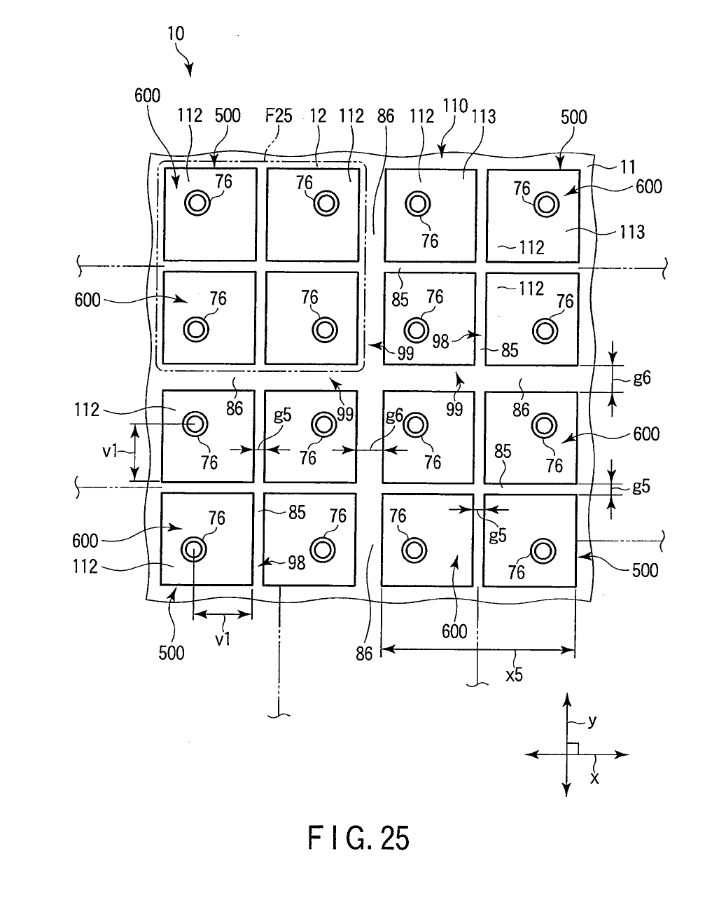

Next, the periodic structure according to the eleventh embodiment will be described using FIGS. 25 to 27. The same reference numerals are attached to components having the similar functions as those in the ninth embodiment and a description thereof is omitted. In the present embodiment, the second conductor patch 121 is different from that in the ninth embodiment. The remaining structure may be the same as that in the ninth embodiment. The above different structure will be described.

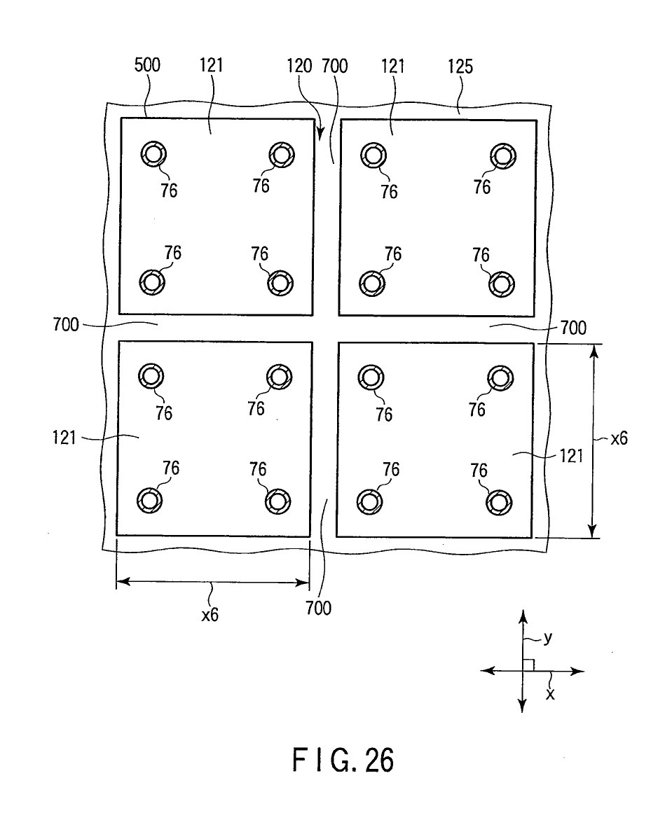

FIG. 25 is a plan view showing a portion of the surface 11 of the periodic structure 10. FIG. 26 is a sectional view showing a state in which the periodic structure 10 is cut between the first patch layer 110 and the second patch layer 120. FIG. 26 shows the second patch layer 120. In FIG. 25, one unit element 12 is shown inside a range F25 indicated by a double-dashed chain line.

As shown in FIG. 26, the flat shape of the second conductor patch 121 is square and each angle thereof is 90 degrees. A set of two sides opposite to each other in circumferences of the second conductor patch 121 is parallel to the x axis direction and the other set of two sides is parallel to the y axis direction.

The second conductor patch 121 constituting the unit element 12 has the same size as that of the four first conductor patches 112 constituting the unit element 12 and is arranged in the lamination direction of the first and second patch layers 110 and 120 in such a way that edges thereof are mutually overlapped. In the present embodiment, the width of the gap 700 defined between the second conductor patches 121 is the same as that of the gap 86.

In the present embodiment, the width x5 of the unit element 12 along the x-axis x and y axis directions is 58 mm. The width x6 of the second conductor patch 121 along the x-axis x and y axis directions is the same as x5 in the present embodiment and is 58 mm. The interval g5 of the gap 85 along the x-axis x and y axis directions inside the unit element 12 is 0.5 mm in the present embodiment. The interval g6 of the gap 86 between the unit elements 12 is 5 mm in the present embodiment. The distance v1 from outer edges to the center of the via 76 inside the unit element 12 is 19.5 mm in the present embodiment. The distance h2 from the surface 11 of the periodic structure 10 to the patch layer 120 is 1.6 mm in the present embodiment. The distance h3 from the surface 11 to the ground layer 50 is 6.4 mm in the present embodiment. In the present embodiment, the dielectric constant is 4.4 and the dielectric dissipation factor is 0.018.

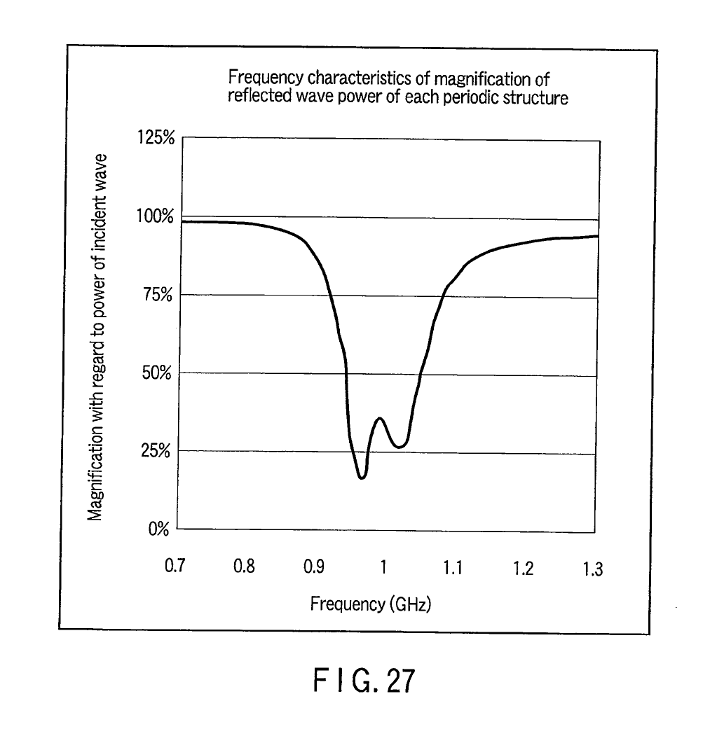

FIG. 27 is similar to FIG. 7 used in the third embodiment and is a graph showing a simulation result of frequency characteristics of reflected power attenuation at a position 157 mm over the surface 11 (in the direction opposite to the direction toward the ground layer 50) of the periodic structure 10. The horizontal axis in FIG. 27 shows the frequency of the incident wave I. The vertical axis in FIG. 27 shows the magnification of reflection electric power with regard to the electric power of the incident wave.

The periodic structure 10 according to the present embodiment is configured for the purpose of controlling reflected waves when the frequency of the incident wave I is 953 MHz (an example of the specific frequency in the present embodiment).

In the present embodiment, the same operation and effect as those in the ninth embodiment can be obtained.

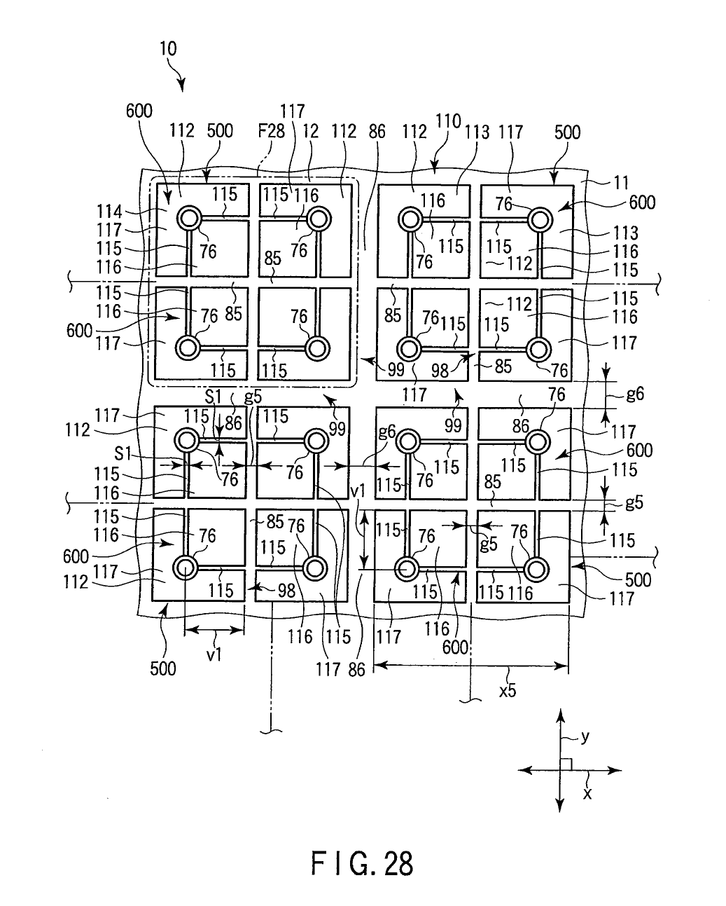

Next, the periodic structure according to the twelfth embodiment will be described using FIGS. 28 to 30. The same reference numerals are attached to components having the similar functions as those in the eleventh embodiment and a description thereof is omitted. In the present embodiment, the first conductor patch 112 is different from that in the eleventh embodiment. Moreover, each dimension is different from that in the eleventh embodiment. The remaining structure may be the same as that in the eleventh embodiment. The above different structure will be described.

FIG. 28 is a plan view showing a portion of the surface 11 of the periodic structure 10. One unit element 12 is shown within a range F28 indicated by a double-dashed chain line. As shown in FIG. 28, slot lines 115 extending from the contour portion 114 of the first conductor patch 112 toward the via 76 are provided. The line 115 passes through the first conductor patch 112. The line 115 extends from the region of four sides (contour portion 114) of the first conductor patch 112 opposite to the first conductor patches 112 adjacent to each other inside the unit element 12 in the x-axis x and y axis direction in parallel.

In other words, the first conductor patch 112 includes a quadrangular portion 116 and an L-shaped portion 117 enveloping the quadrangular portion 116. The quadrangular portion 116 specifies a portion of the gap 85 inside the unit element 12. The L-shaped portion 117 specifies the gap 86 between the unit elements 12. A contour portion of the quadrangular portion 116 and that of the L-shaped portion 117 are electrically connected to a top edge of the via 76. The first conductor patch 112 constituting the unit element 12 may be the same as that in the eleventh embodiment excluding the above different point from the eleventh embodiment.

The width of the line 115 is set as s1 and s1 is constant. In other words, sides of the quadrangular portion 116 defining s1 and those of the L-shaped portion 117 are parallel. The center of the width s1 of the line 115 passes through the center of the via 76.

The width of the unit element 12 along the x-axis x and y axis directions is set as x5 and x5=57 mm is set in the present embodiment. The width g5 of the gap 85 inside the unit element 12 is set as g5=0.5 mm in the present embodiment. The width g6 of the gap 86 between the unit elements 12 along the x-axis x and y axis directions is set as g6=5 mm in the present embodiment. The distance from the center of the via 76 to the gap 85 inside the unit element 12 is set as v1 and v1=19 mm is set in the present embodiment. In particular, distance v1 is the distance from the center of the via 76 to the edge of the quadrangular portion 116 which defines the gap 85.

Dimensions of the quadrangular portion 116 and the L-shaped portion 117 are adjusted to make the phase difference between electromagnetic waves reflected by the gaps 84 and 85 180 degrees.

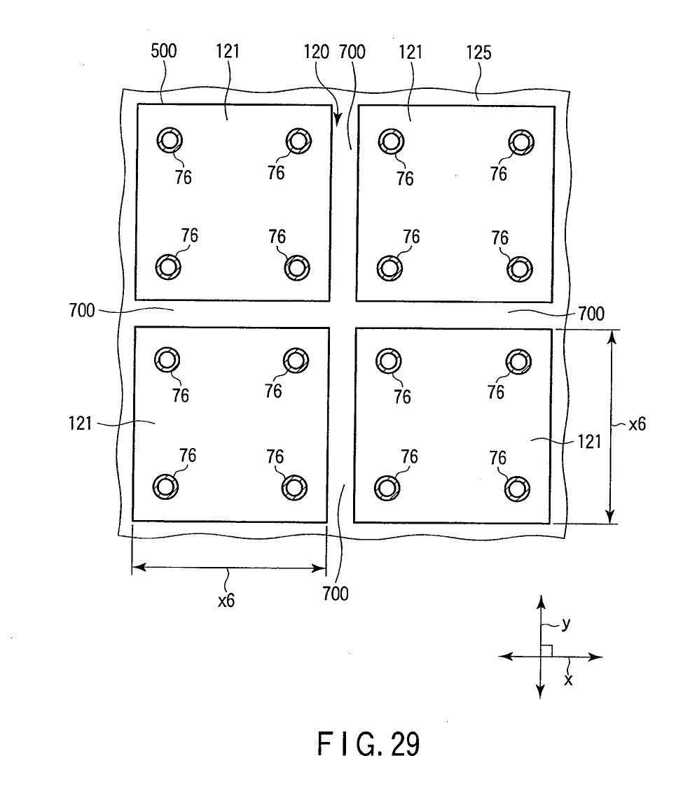

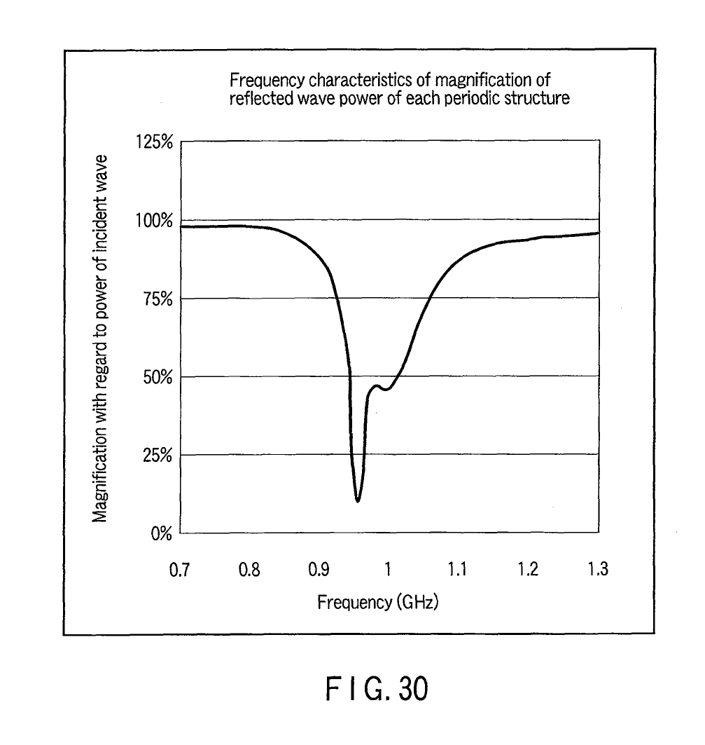

FIG. 29 is a sectional view of the periodic structure 10 obtained by cutting the periodic structure 10 between the first patch layer 110 and the second patch layer 120. FIG. 29 shows the second patch layer 120. The second patch layer 120 has the same structure as that in the eleventh embodiment and is square. The width x6 of the second conductor patch 121 is the same as x5 in the present embodiment and is 57 mm. FIG. 30 is similar to FIG. 7 used in the third embodiment and is a graph showing a simulation result of frequency characteristics of reflected power attenuation at a position 157 mm over the surface 11 (in the direction opposite to the direction toward the ground layer 50) of the periodic structure 10. The horizontal axis in FIG. 30 shows the frequency of the incident wave I. The vertical axis in FIG. 30 shows the magnification of electric power of the reflected wave with regard to the electric power of the incident wave.

The periodic structure 10 according to the present embodiment is configured for the purpose of controlling reflected waves when the frequency of the incident wave I is 953 MHz (an example of the specific frequency in the present embodiment). In the present embodiment, the same operation and effect as those in the tenth embodiment can be obtained.

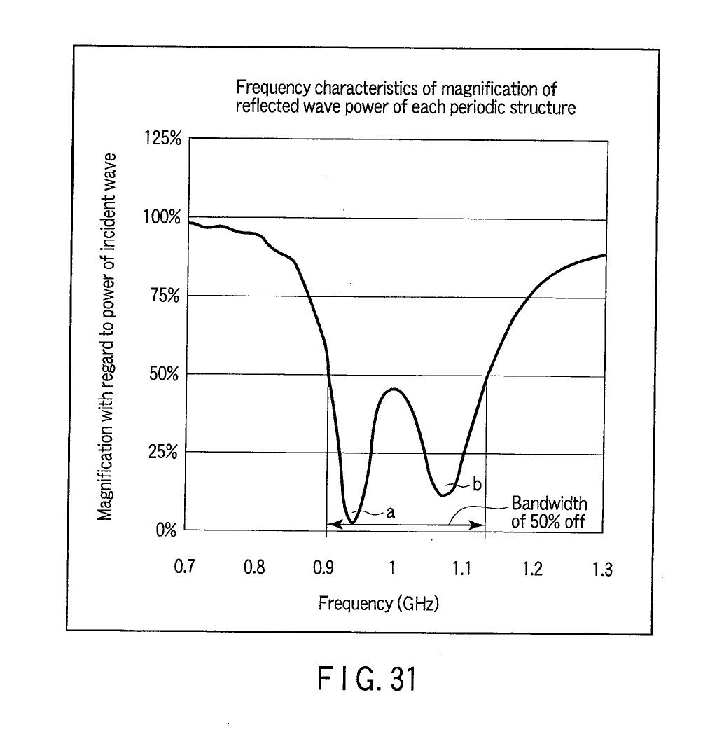

Next, the periodic structure according to the thirteenth embodiment will be described using FIG. 31. The same reference numerals are attached to components having the similar functions as those in the eighth embodiment and a description thereof is omitted. The periodic structure 10 in the present embodiment is different from the eighth embodiment in the value of the dielectric dissipation factor of the first and second insulating layers 130 and 140. The remaining structure is the same as that in the eighth embodiment.

In the present embodiment, the value of the dielectric dissipation factor of the first and second insulating layers 130 and 140 is 0.04. FIG. 31 is similar to FIG. 7 used in the third embodiment and is a graph showing a simulation result of frequency characteristics of reflected power attenuation at a position 157 mm over the surface 11 (surface 113) (in the direction opposite to the direction toward the ground layer 50) of the periodic structure 10 according to the present embodiment.

In the eighth embodiment, the dielectric dissipation factor of the first and second insulating layers 130 and 140 is 0.018. Thus, when compared with the eighth embodiment, the loss component in the present embodiment is large. Therefore, in the present embodiment, not only the same effect as that in the eighth embodiment is obtained, but also the effect of controlling reflected waves is large when compared with the eighth embodiment.

A growing effect of controlling reflected waves will be described by comparing with the eighth embodiment. In the eighth embodiment, as shown in FIG. 18, two valleys (represented by a and b in FIG. 18) are close to each other and the maximum value of the magnification of a reflected wave between the valleys with regard to the electric power of an incident wave is 69% (1 GHz) and thus, the bandwidth of 50% off is increased by increasing the loss component of the periodic structure 10. While the bandwidth of 50% off is 232 MHz in the present embodiment, the bandwidth of 50% off in the eighth embodiment is smaller than that in the present embodiment. Incidentally, the bandwidth to become 50% off in the valley a in FIG. 18 is 42 MHz.

Setting the value of the dielectric dissipation factor of the first and second insulating layers 130 and 140 to 0.04 is only an example and is not limited to this value.

By forming the first and second insulating layers 130 and 140 by using a loss material with a larger loss component, a large effect of controlling reflected waves can be obtained. The loss material in the present embodiment is a material to which a magnetic permeability loss is added by mixing magnetic powder in a resin or a material to which a dielectric loss is added by dispersing a conductive material in an insulator. Materials sold in the market as wave absorbers may also be used as these loss materials.

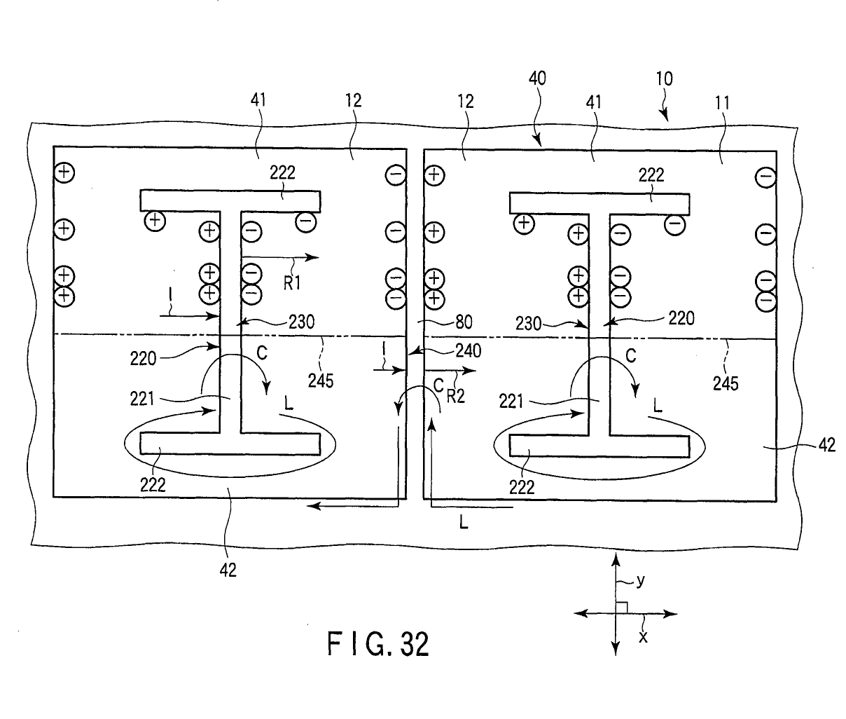

Next, the periodic structure according to the fourteenth embodiment will be described using FIG. 32. The same reference numerals are attached to components having the similar functions as those in the first embodiment and a description thereof is omitted. The present embodiment is different from the first embodiment in the structure of the conductor patch 41 and the facts that the plate-type connecting conductor 70 is not included and LC resonance circuits 230 and 240 are formed in place of the LC resonance circuits 90 and 91. The remaining structure may be the same as that in the first embodiment. The above different structure will be described.

FIG. 32 is a plan view showing a portion of the surface 11 (surface 42) of the periodic structure 10. As shown in FIG. 32, the conductor patch 41 has an I-shaped line portion 220 extending in parallel in the y axis direction and also extending in parallel in the x axis direction at both ends formed therein. The line portion 220 passes through the conductor patch 41. The line portion 220 forms the LC resonance circuit 230.

The conductor patch 41 is square in the present embodiment and the center of the line portion 220 is positioned in the center of the conductor patch 41. The line portion 220 has a shape symmetrical about the center of the line portion 220 in the x-axis x and y axis directions.

The LC resonance circuit 230 will be described. If an incident wave contains a linear polarization component along the x axis direction, a linear portion 221 extending in parallel in the y axis direction in the line portion 220 of the LC resonance circuit 230 functions as a capacitor and portions 222 extending in parallel in the x axis direction from both ends of the linear portion 221 function as a coil. The LC resonance circuit 240 in which the gap 80 defined between the conductor patches 41 functions as a capacitor is formed between the conductor patches 41.

In the present embodiment, the unit element 12 is constituted of one conductor patch 41. The present embodiment includes the LC resonance circuits 230 and 240 and thus includes two types of LC resonance circuits.

In the upper part from a boundary 245 indicated by a double-dashed chain line in FIG. 32, a charge distribution at some instant is schematically depicted. The boundary 245 is a line used for the sake of convenience to describe the state of charge distribution and the boundary is not actually provided in the conductor patch 41. As shown in FIG. 32, the sign of charges around the linear portion 221, which is a gap inside the unit element 12 (conductor patch 41) and that of charges around the gap 80 defined between the conductor patches 41 are mutually different.

Thus, the phase difference of a reflected wave reflected by the linear portion 221 of the LC resonance circuits 230 and 240 and the gap 80 becomes 180 degrees. In the present embodiment, the LC resonance circuit 230 reflects the first reflected wave R1. The LC resonance circuit 240 reflects the second reflected wave R2. The first and second reflected waves R1 and R2 have a phase difference of 180 degrees and thus cancel out each other.

The present embodiment can obtain the same effect as that in the first embodiment. Further, a structure in which the LC resonance circuit 230 is formed inside the conductor patch 41 without using a connecting conductor connecting the conductor patch 41 and the ground layer 50 is adopted and thus, it becomes unnecessary to process the connecting conductor such as the plate-type connecting conductor 70 so that the structure of the periodic structure 10 can be simplified.

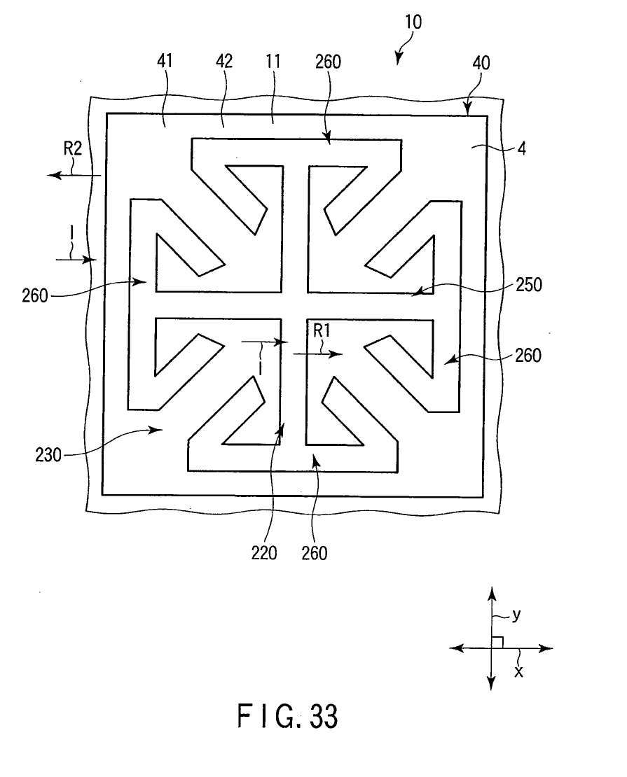

Next, the periodic structure according to the fifteenth embodiment will be described using FIG. 33. The same reference numerals are attached to components having the similar functions as those in the fourteenth embodiment and a description thereof is omitted. In the present embodiment, the line portion 220 constituting the LC resonance circuit 230 inside the conductor patch 41 is different from that in the fourteenth embodiment. The remaining structure may be the same as that in the fourteenth embodiment. The above different structure will be described.

FIG. 33 is a plan view showing a portion of the surface 11 of the periodic structure 10. As shown in FIG. 33, the line portion 220 includes a +(plus)-shaped cross portion 250 arranged in the center of the conductor patch 41 and straight line portions 260 extending in parallel in the x-axis x and y axis directions from ends of the cross portion 250.

The cross portion 250 functions as a capacitor. The cross portion 250 is +-shaped and thus, regardless of whether an incident wave contains a linear polarization component in the x axis direction or y axis direction, the cross portion 250 functions as a capacitor. In the present embodiment, the conductor patch 41 is square and the center of the cross portion 250 matches the center of the conductor patch 41.

The straight line portion 260 functions as a coil. The portion functioning as a coil can be extended by bending both ends of the straight line portion 260. In the present embodiment, both ends of the straight line portion 260 are bent toward the center of the conductor patch 41. In this manner, the length of the portion functioning as a coil can be adjusted. The line portion 220 is symmetrical about the center thereof in the x-axis x and y-axis t directions.

Even in the present embodiment, the same operation and effect as those in the fourteenth embodiment can be obtained. Further, regardless of whether an incident wave contains a linear polarization component in the x axis direction or y axis direction, reflected waves can be controlled.

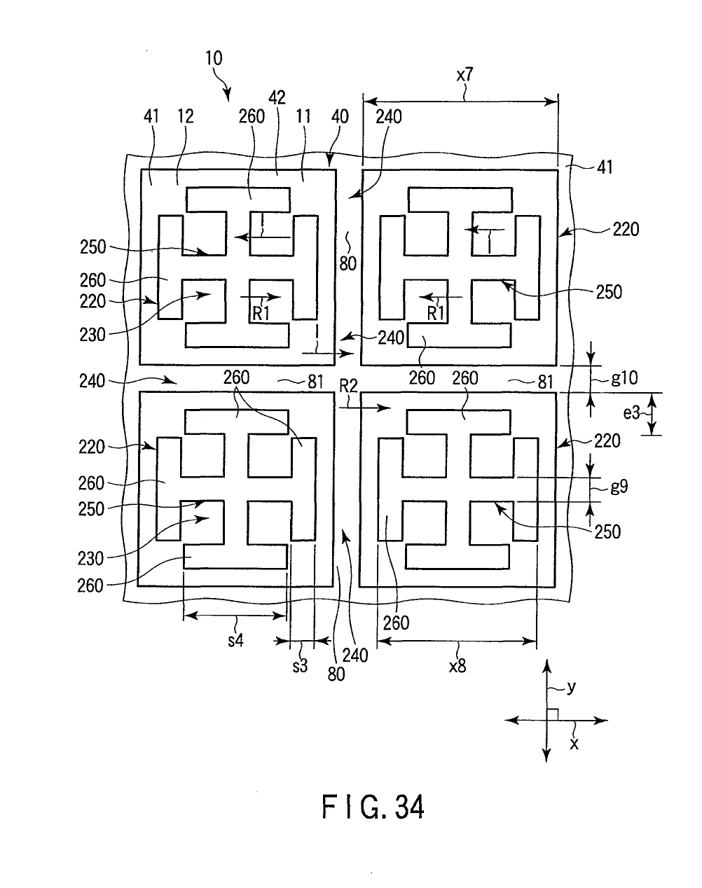

Next, the periodic structure according to the sixteenth embodiment will be described using FIGS. 34, 35, and 47. The same reference numerals are attached to components having the similar functions as those in the fifteenth embodiment and a description thereof is omitted. In the present embodiment, the conductor patch 41 is different from that in the fifteenth embodiment. The remaining structure may be the same as that in the fifteenth embodiment. The above different structure will be described.

FIG. 34 is a plan view showing a portion of the surface 11 of the periodic structure 10. As shown in FIG. 34, one conductor patch 41 constitutes the unit element 12. The line portion 220 is formed in the center of the conductor patch 41.

The line portion 220 includes the cross portion 250 and the straight line portions 260 extending in parallel in the x-axis x and y axis directions. In the present embodiment, the straight line portions 260 are not bent toward the center of the conductor patch 41.

The width of the conductor patch 41 (unit element 12) along the x-axis x and y axis directions is set as x7 and x7=27 mm is set in the present embodiment. The width of the gap (cross portion 250) inside the unit element 12 is set as g9 and g9-0.5 mm is set in the present embodiment. The width of the gaps 80 and 81 between the unit elements 12 is set as g10 and g10=1 mm is set in the present embodiment. The width of the straight line portion 260 is set as s3 and s3=1 mm is set in the present embodiment. The length of the straight line portion 260 is set as s4 and s4=19 mm is set in the present embodiment. The length between outer edges is set as x8 and x8=25 mm is set in the present embodiment. h3 that is the distance from the surface 11 of the periodic structure 10 to the ground layer 50 is set to 6.4 mm in the present embodiment. In the present embodiment, the dielectric constant is 4.4 and the dielectric dissipation factor is 0.018.

Also in the present embodiment, the LC resonance circuit 230 is formed by the line portion 220 and the LC resonance circuit 240 is formed between the unit elements 12. In this manner, two types of LC resonance circuits are formed and reflected waves by both types of LC resonance circuit cancel out each other and thus, reflected waves are controlled.

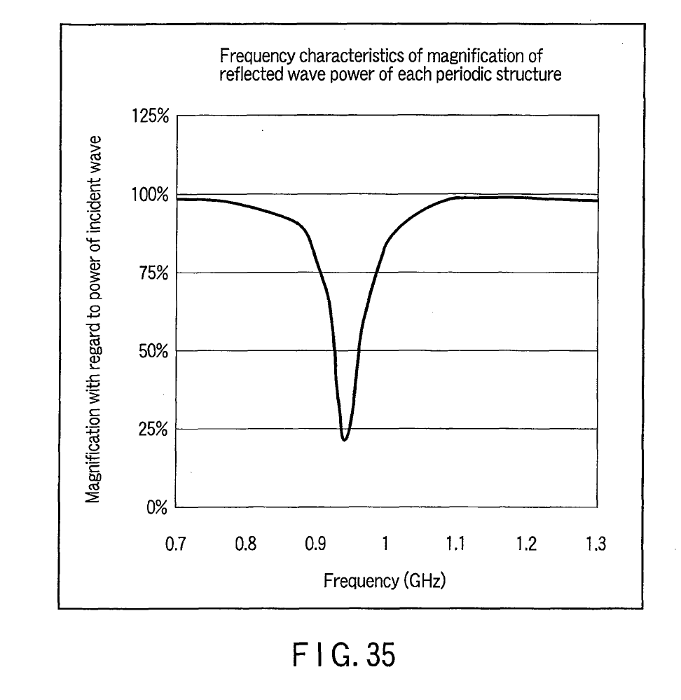

FIG. 35 is similar to FIG. 7 used in the third embodiment and is a graph showing a simulation result of frequency characteristics of reflected power attenuation at a position 157 mm over the surface 11 (in the direction opposite to the direction toward the ground layer 50) of the periodic structure 10. The horizontal axis in FIG. 35 shows the frequency of the incident wave I. The vertical axis in FIG. 35 shows the magnification of electric power of the reflected wave with regard to the electric power of the incident wave.

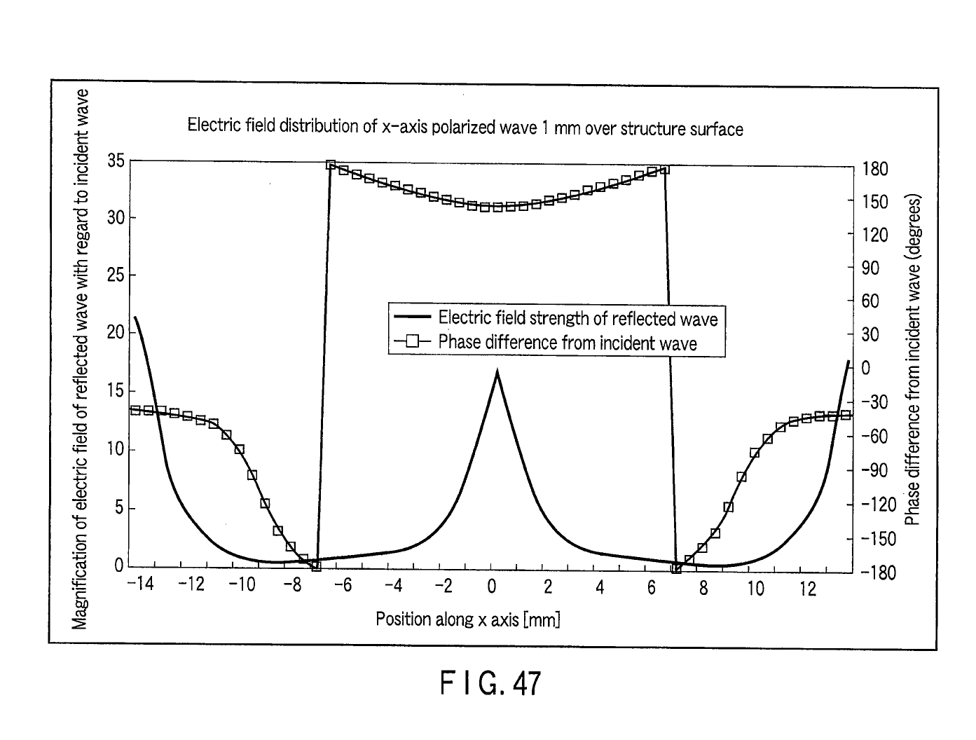

FIG. 47 is a graph showing a simulation result of the x-axis component of an electric field at a position 1 mm over the surface 11 (in the present embodiment, the surface 42) (in the direction opposite to the direction toward the ground layer 50) of the periodic structure 10 and, as shown in FIG. 34, a distance e3 from the end of the conductor patch 41 in the y axis direction. In the present embodiment, e3=6.5 mm is set.

The horizontal axis in FIG. 47 is similar to that in FIG. 6 used in the second embodiment and shows the position along the x axis direction. The position where the horizontal axis indicates 0 is the center of the unit element 12 along the x axis direction. In the present embodiment, the graph is shown with positive values on the right side of FIG. 47 and negative values on the left side. The vertical axis in FIG. 47 is similar to that in FIG. 6 and shows the magnification of an electric field of the component along the x axis direction of a reflected wave with regard to an incident wave at a position 1 mm over the surface 11.

Even in the present embodiment, the same operation and effect as those in the fifteenth embodiment can be obtained.

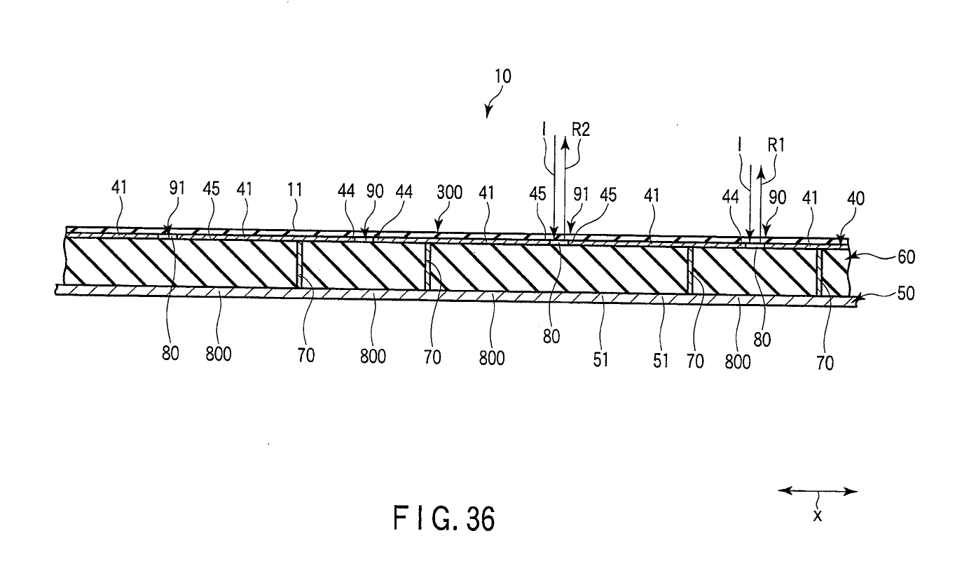

Next, the periodic structure according to the seventeenth embodiment will be described using FIG. 36. The same reference numerals are attached to components having the similar functions as those in the first embodiment and a description thereof is omitted. The present embodiment is different from the first embodiment in that an insulating layer 300 is stacked on the patch layer 41. The remaining structure may be the same as that in the first embodiment. The above different structure will be described.

FIG. 36 is a sectional view showing the state in which the periodic structure 10 is cut in the lamination direction. As shown in FIG. 36, the insulating layer 300 is stacked on the patch layer 41. In other words, the insulating layer 300 is stacked on LC resonance circuits. The insulating layer 300 is formed of a dielectric material. The insulating layer 300 has a size to cover the entire area of the patch layer 40. The insulating layer 300 is an example of the insulating layer further stacked on LC resonance circuits in the present embodiment.

In the present embodiment, the same effect and operation as those in the first embodiment can be obtained. Further, the insulating layer 300 functions as a spacer to minimize an influence to which the LC resonance circuits 90 and 91 are subjected from surrounding objects. Covering the LC resonance circuits 90 and 91 with the insulating layer 300 also contributes to miniaturization of the LC resonance circuits 90 and 91 thanks to a wavelength shortening effect of an insulator.

In the present embodiment, the insulating layer 300 is provided in the periodic structure 10 described in the first embodiment, but the present embodiment is not limited to this. Like the present embodiment, the insulating layer 300 may be stacked on the patch layer 40 in the periodic structure 10 described in the second to fifth embodiments. Even in such cases, the same effect as that in the present embodiment can further be obtained.

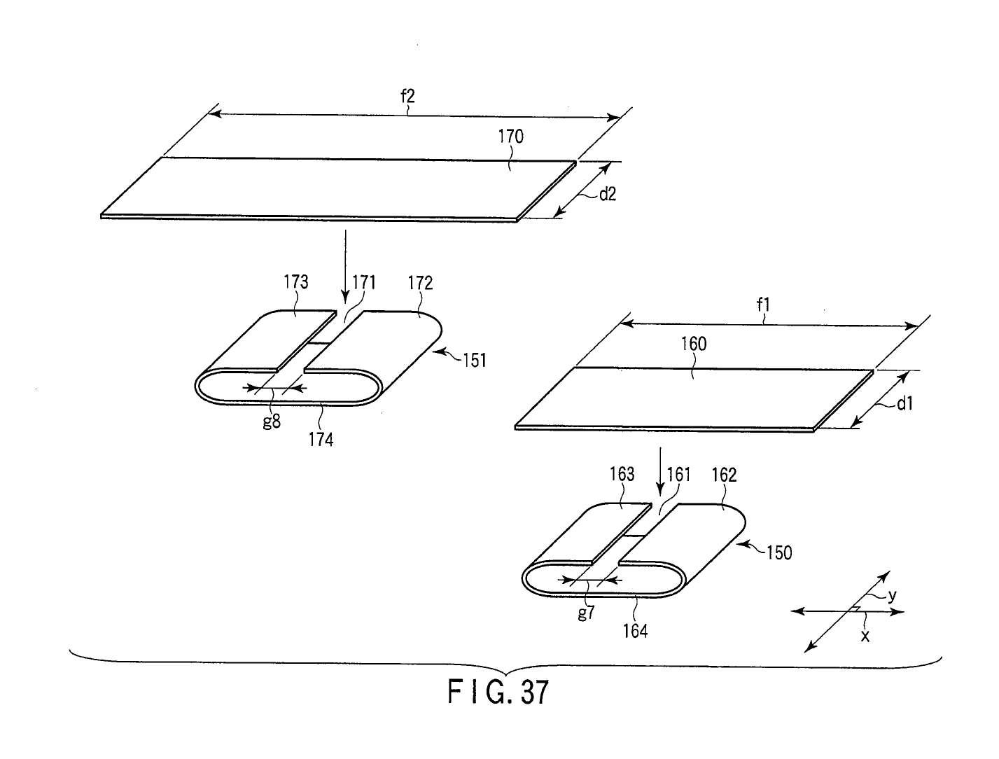

Next, the periodic structure according to the eighteenth embodiment will be described using FIGS. 37 to 42. The same reference numerals are attached to components having the similar functions as those in the fifth embodiment and a description thereof is omitted. In the present embodiment, three types of LC resonance circuits 150, 151, and 152 are provided inside the unit element 12, in place of the LC resonance circuits 96 and 97. Also, the structures of the first and second insulating layers 130 and 140 are different. The remaining structure may be the same as that in the fifth embodiment. The above different structure will be described.

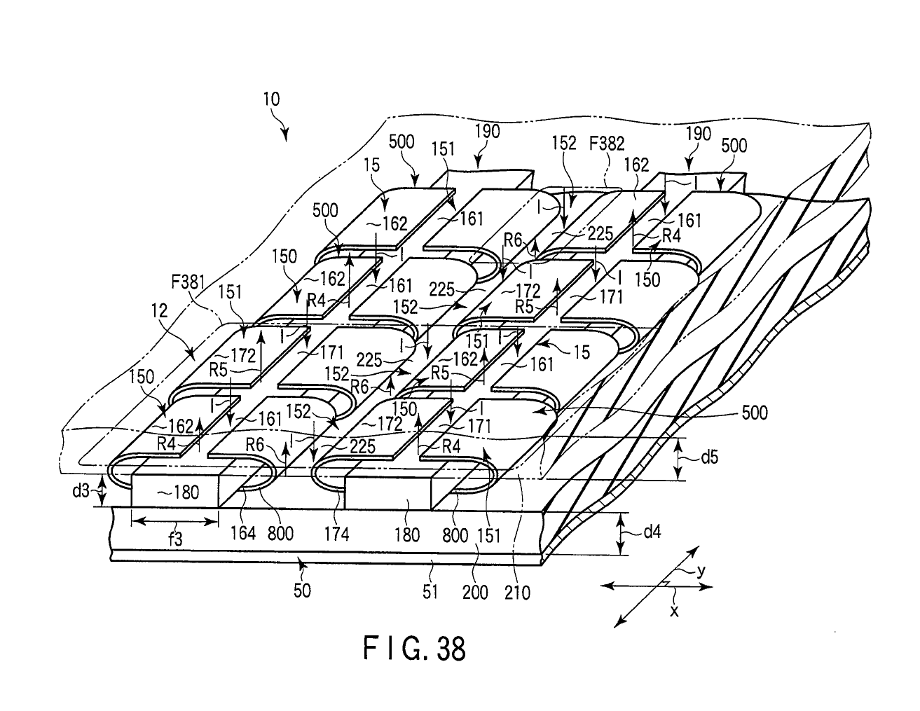

FIG. 38 is a perspective view of the periodic structure 10 by cutting out a portion thereof. As shown in FIG. 38, the LC resonance circuits 150, 151, and 152 are provided in the present embodiment. FIG. 37 is a schematic diagram showing how the LC resonance circuits 150 and 151 are formed. As shown in FIG. 37, the LC resonance circuit 150 is formed of a first member 160. The first member 160 is a plate member made of copper and having a fixed thickness in a plate shape with a width d1 (in the present embodiment, as an example, 50 mm) and a length f1 (in the present embodiment, as an example, 150 mm). The flat shape thereof is quadrangular and each angle is 90 degrees.

The first member 160 has a gap 161 between both ends formed by being bent like a C tube and also being squeezed so that the gap 161 is oriented upward. An interval g7 of the gap 161 is, as an example, 3 mm and is constant in the direction in which the gap 161 extends.

The LC resonance circuit 151 is formed of a second member 170. The second member 170 is a plate member made of copper (as an example, the same material as the first member 160) and having a fixed thickness (as an example, the same thickness as that of the first member 160) in a plate shape with a width d2 (in the present embodiment, as an example, 50 mm) and a length f2 (in the present embodiment, as an example, 164 mm). The flat shape thereof is quadrangular and each angle is 90 degrees. The LC resonance circuit 151 is formed in such a way that the second member 170 has a gap 171 between both ends formed by being bent like a C tube and also being squeezed so that the gap 171 is oriented upward. An interval g8 of the gap 171 is 3 mm and is constant in the direction in which the gap 171 extends.

The LC resonance circuits 150 and 151 configured as described above have upper wall portions 162 and 172 as sides where the gaps 161 and 171 are arranged, respectively. Sides facing the outside in the upper wall portions 162 and 172 are defined as surfaces 163 and 173, respectively. Wall portions opposite to the upper wall portions 162 and 172 are defined as lower wall portions 164 and 174, respectively.

As shown in FIG. 38, the LC resonance circuits 150 and 151 are mounted on a rod cellular porous medium 180. The rod cellular porous medium 180 constitutes the first insulating layer 130. The rod cellular porous medium 180 has a quadrangular sectional shape, a thickness d3 (in the present embodiment, as an example, 10 mm), and a width f3 (in the present embodiment, as an example, 35 mm) and extends linearly. The rod cellular porous medium 180 is passed through the LC resonance circuits 150 and 151. In this case, the rod cellular porous medium 180 is in surface contact with the upper wall portions 162 and 172 and the lower wall portions 164 and 174.

A plurality of the LC resonance circuits 150 and 151 is alternately arranged on the rod cellular porous medium 180 and arranged, as an example, at intervals of 2 mm. In this case, the number of the LC resonance circuits 150 and that of the LC resonance circuits 151 mounted on the rod cellular porous medium 180 are assumed to be the same even number. More specifically, if the four LC resonance circuits 150 are mounted, the four LC resonance circuits 151 are mounted.

A plurality of units 190 configured by the LC resonance circuits 150 and 151 being imposed on the rod cellular porous medium 180 is provided. As an example, a copper plate is used as the ground plate 51 constituting the ground layer 50. As the second insulating layer 140, a plate cellular porous medium 200 with a thickness d4 (in the present embodiment, as an example, 14 mm) is used. The plate cellular porous medium 200 is stacked on the ground layer 50.

Each of the units 190 is stacked on the plate cellular porous medium 200. In this case, the direction in which the rod cellular porous medium 180 extends, in other words, the direction in which the LC resonance circuits 150 and 151 are alternately placed along the rod cellular porous medium 180 is made parallel to the y axis direction and the direction in which each of the unit 190 is placed is made parallel to the x axis direction. Each of the units 190 is placed so that the LC resonance circuits 150 and 151 are alternately arranged in the x axis direction. Thus, the LC resonance circuits 150 and 151 are alternately arranged in the x-axis x and y axis directions. The upper wall portions 162 and 172 have the same height with regard to the ground layer 50. The lower wall portions 164 and 174 have the same height with regard to the ground layer 50.

The number of the units 190 is set to the same even number of the respective LC resonance circuits 150 and 151 on the rod cellular porous medium 180. More specifically, if the four LC resonance circuits 150 and the four LC resonance circuits 151 are provided on the rod cellular porous medium 180, the number of the units 190 is set to four. By setting the respective numbers of the LC resonance circuits 150 and 151 to the same even number and the number of the units 190 to the same even number, the center of the periodic structure 10 will be surrounded by the two LC resonance circuits 150 and the two LC resonance circuits 151.

In FIG. 38, the unit element 12 is shown inside a range F381 indicated by a double-dashed chain line. In the present embodiment, the unit element 12 includes a total of four LC resonance circuits, the LC resonance circuits 150 and 151 placed in the x axis direction and the LC resonance circuits 150 and 151 placed in the y axis direction with regard to these LC resonance circuits.

When a plurality of the units 190 is placed, the interval between the LC resonance circuits 150 and 151 adjacent to each other in the x axis direction is set, as an example, to 3 mm. A plate cellular porous medium 210 of a thickness d5 (in the present embodiment, as an example, 10 mm) is stacked on each of the units 190. In FIG. 38, the plate cellular porous medium 210 is indicated by a double-dashed chain line. The periodic structure 10 is arranged in such a way that the direction (y axis direction) in which the gaps 161 and 171 extend is perpendicular to a longer direction A of the RFID tag 23. The longer direction A of the RFID tag 23 is shown in FIG. 1.

In the periodic structure 10 configured as described above, the upper wall portions 162 and 172 function as the first conductor patch 112 in the fifth embodiment and an assembly of the upper wall portions 162 and 172 functions as the first patch layer 110 in the fifth embodiment. The lower wall portions 164 and 174 function as the second conductor patch 121 in the fifth embodiment and an assembly of the lower wall portions 164 and 174 becomes the second patch layer 120 in the fifth embodiment. A portion connecting the upper wall portions 162 and 172 and the lower wall portions 164 and 174 functions as a connecting conductor. A pair of the upper wall portions 162 and 172 included in the LC resonance circuits 150 and 151 constitutes the conductor patch unit 500 (also an example of the combination in the embodiment).

The LC resonance circuit 152 is also formed between the LC resonance circuits 150 and 151 adjacent to each other in the x axis direction. In FIG. 38, the LC resonance circuit 152 is shown inside a range F382 indicated by a double-dashed chain line. A gap 225 defined between the LC resonance circuits 150 and 151 functions as a capacitor of the LC resonance circuit 152.

In this manner, three types of the LC resonance circuits 150 to 152 are formed in the present embodiment. The LC resonance circuit 150 reflects a fourth reflected wave R4. The LC resonance circuit 151 reflects a fifth reflected wave R5. The LC resonance circuit 152 reflects a sixth reflected wave R6. The fourth to sixth reflected waves R4 to R6 have phase differences that cancel out one another.

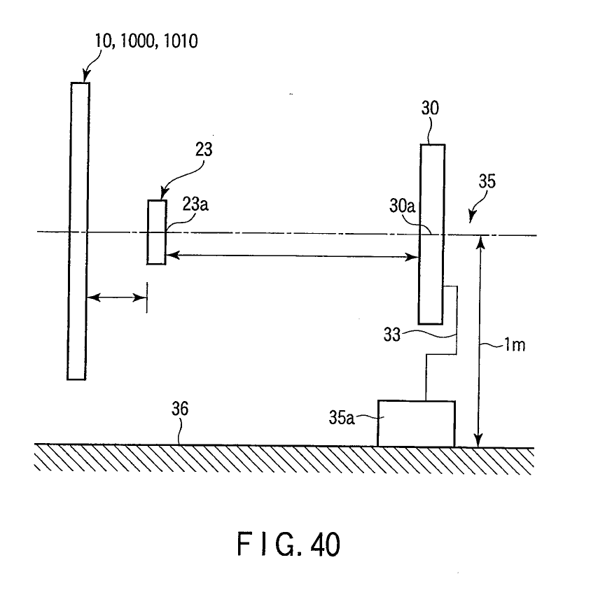

Next, an experiment to measure a reading distance of the RFID tag 23 regarding the distance between the RFID tag 23 and the periodic structure 10 will be described. FIG. 40 shows conditions for the above experiment. As shown in FIG. 40, a dipole type antenna in the UHF band is used, as an example, for the RFID tag 23. Output of an RFID tag reader 35 is set at 50 mW and a circularly polarized wave is used for the antenna 30 of the RFID tag reader 35. A main body 35a of the RFID tag reader 35 and the antenna 30 are connected by a cable 33. In the RFID tag reader 35, an antenna gain including the cable 33 is set at 4.1 dBi.

The RFID tag 23 and the antenna 30 of the RFID tag reader 35 are arranged in such a way that a center 30a of the antenna 30 and a center 23a of the RFID tag 23 are aligned on a straight line 1 m over a floor 36. In FIG. 40, how the centers 30a and 23a are aligned on a straight line is shown by an alternate short and long dashed line.

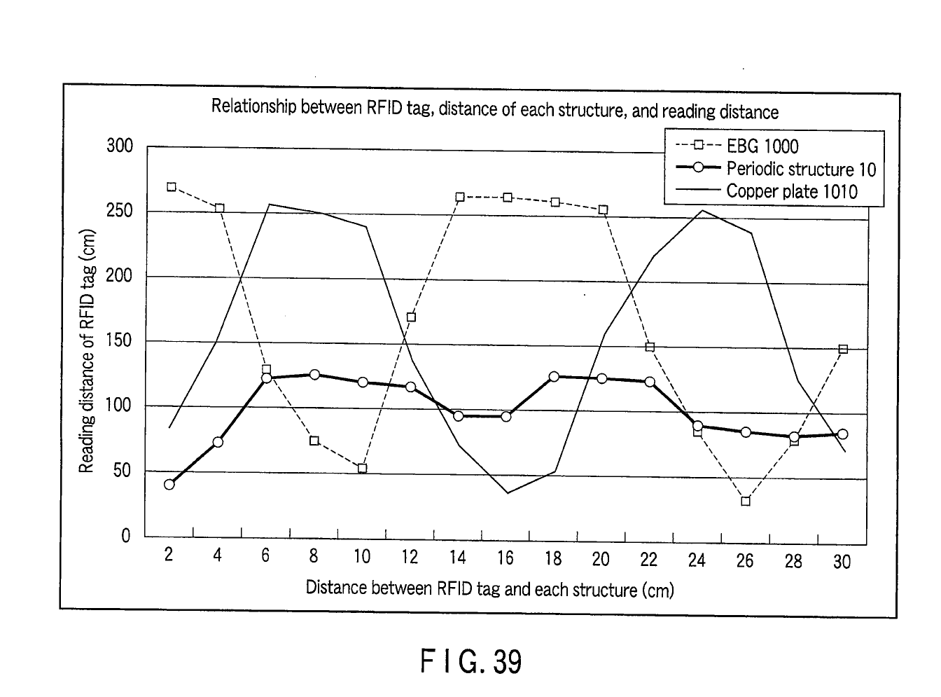

FIG. 39 is a graph showing an experiment result of the experiment to measure the reading distance of the RFID tag 23 regarding the distance between the RFID tag 23 and the periodic structure 10. In the graph shown in FIG. 39, the horizontal axis shows the distance between the RFID tag 23 and the periodic structure 10. The unit thereof is cm (centimeters). The vertical axis thereof shows the reading distance of the RFID tag. The unit thereof is cm. The reading distance of the RFID tag here is a value of distance that makes the RFID tag unreadable if farther away from this distance.

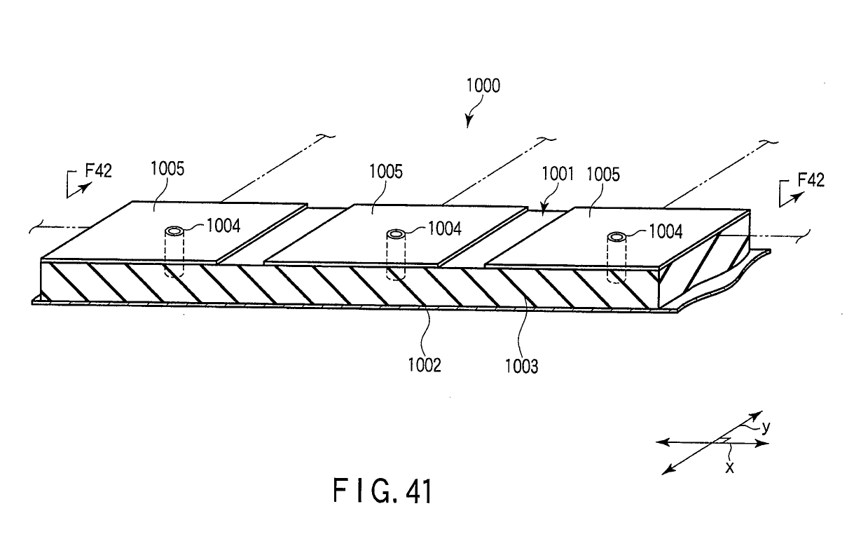

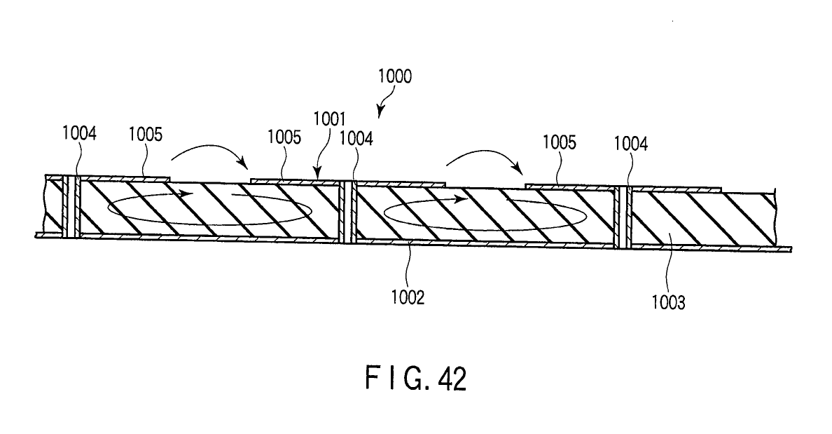

FIG. 39 also shows an experiment result of the experiment shown in FIG. 40 when, instead of the periodic structure 10, a general EBG (Electronic Band Gap) 1000 is used. FIG. 41 is a perspective view showing the EBG 1000. FIG. 42 is a sectional view of the EBG 1000 along an F42-F42 line shown in FIG. 41. As shown in FIGS. 41 and 42, the EBG 1000 includes a patch layer 1001, a ground layer 1002, an insulating layer 1003, and a via 1004. The EBG 1000 is of the mushroom type.

The EBG 1000 is constituted of, for example, a board having a copper foil layer on both sides thereof. The patch layer 1001 is formed from one copper foil layer of the board and the other copper foil layer becomes the ground layer 1002. The insulating layer 1003 is formed between both the copper foil layers.

The patch layer 1001 includes a plurality of patch conductors 1005 in a square shape. A pair of sides opposite to each other of these patch conductors 1005 is parallel to the x axis direction and the other pair of sides is parallel to the y axis direction. The patch conductors 1005 adjacent to each other are placed in parallel with an interval of 1 mm therebetween. The patch conductors 1005 are formed by removing portions other than the patch conductors 1005 from the copper foil layer on the surface of the board. The thickness of the insulating layer 1003 is 20 mm. The via 1004 has the same structure as that of the vias 71 and 76 shown in the above embodiments and the center thereof is arranged in the center of the patch conductor 1005.

FIG. 39 also shows an experiment result of the experiment shown in FIG. 40 when, instead of the periodic structure 10, a copper plate 1010 is used.

As shown in FIG. 39, when compared with a case where the copper plate 1010 is used instead of the periodic structure 10 or a case where the EBG 1000 is used instead of the periodic structure 10, the change of the reading distance with regard to the distance between the periodic structure 10 and the RFID tag 23 is small. In other words, an influence caused by reflected waves from the periodic structure 10 is small. In the present embodiment, the same operation and effect as those in the fifth embodiment can be obtained.

The plate cellular porous medium 210 corresponds to the insulating layer 300 described in the seventeenth embodiment and thus functions as a spacer that minimizes an influence from surroundings. Moreover, by adjusting the dielectric constant of the plate cellular porous medium 210, like the seventeenth embodiment, the periodic structure 10 can be made smaller.

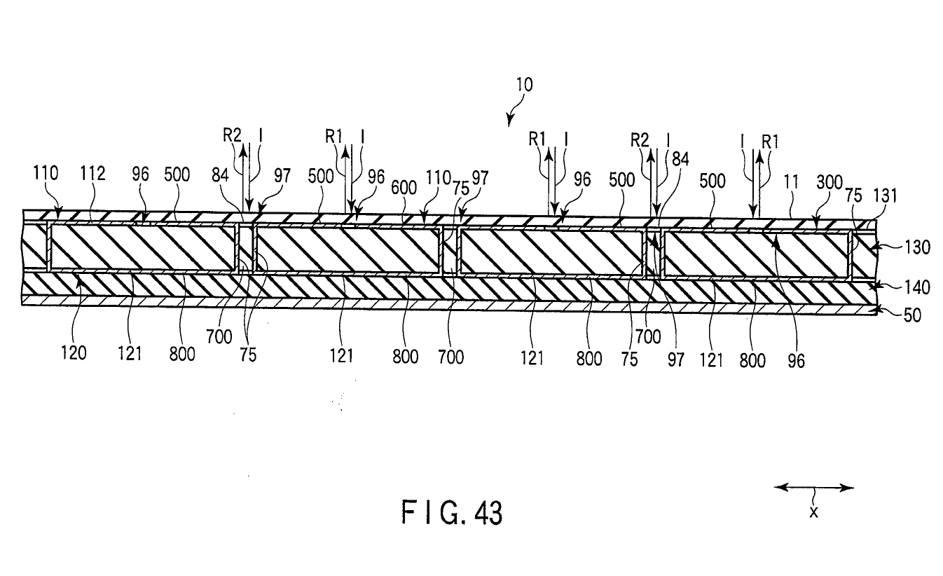

Next, the periodic structure according to the nineteenth embodiment will be described using FIG. 43. The same reference numerals are attached to components having the similar functions as those in the fifth embodiment and a description thereof is omitted. The present embodiment is different from the fifth embodiment in that the insulating layer 300 described in the seventeenth embodiment is stacked on the first patch layer 110. The remaining structure may be the same as that in the fifth embodiment. The above different structure will be described.

FIG. 43 is a sectional view showing a state in which the periodic structure 10 is cut in the lamination direction. As shown in FIG. 43, the insulating layer 300 is stacked on the first patch layer 110.

In the present embodiment, the operation and effect in the fifth embodiment can be obtained. Further, the insulating layer 300 functions as a spacer that minimizes an influence to which the LC resonance circuits 96 and 97 are subjected from surrounding objects. Moreover, covering the LC resonance circuits 96 and 97 with the insulating layer 300 also contributes to miniaturization of the LC resonance circuits 96 and 97 thanks to the wavelength shortening effect of an insulator by adjusting the dielectric constant of the insulating layer 300.

The insulating layer 300 is stacked on the first patch layer 110 of the periodic structure 10 according to the eighteenth or nineteenth embodiment, but the present embodiment is not limited to this. For example, the insulating layer 300 may be stacked on the first patch layer 110 of the periodic structure 10 according to the sixth to thirteenth embodiments. Even in such a case, the same effect as that in the eighteenth or nineteenth embodiment can further be obtained by adjusting the dielectric constant of the insulating layer 300.

Next, the periodic structure according to the twentieth embodiment will be described using FIGS. 44 to 46. The same reference numerals are attached to components having the similar functions as those in the sixteenth embodiment and a description thereof is omitted. The present embodiment is different from the sixteenth embodiment in that the insulating layer 300 used in the seventeenth embodiment is stacked on the patch layer 40 and each dimension is different from that in the sixteenth embodiment. The remaining structure may be the same as that in the seventeenth embodiment. The above different structure will be described.

FIG. 44 is a sectional view showing a state in which the periodic structure 10 is cut in the lamination direction. As shown in FIG. 44, the periodic structure 10 has the insulating layer 300 stacked on the patch layer 40. The insulating layer 300 is formed of a dielectric material. The insulating layer 300 has a size to cover the entire area of the patch layer 40.

The length from the surface 11 (in the present embodiment, a surface 301 of the insulating layer 300) of the periodic structure 10 to the surface 42 of the patch layer 40 is set as h1 and h1=1.6 mm is set in the present embodiment. h3 that is the distance from the surface 11 to the ground layer 50 is set as h3=6.4 mm in the present embodiment.

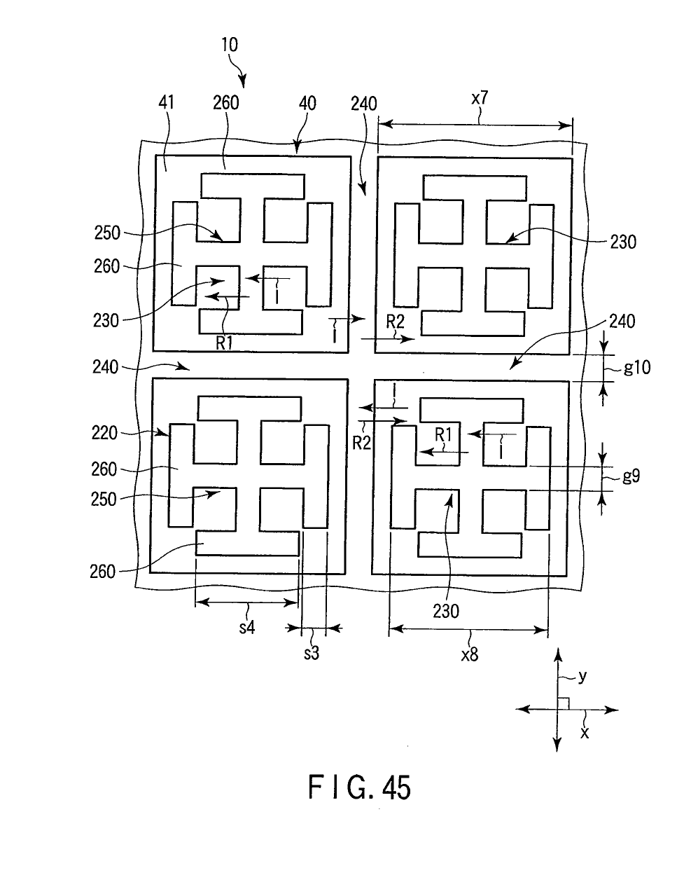

FIG. 45 is a sectional view of the periodic structure 10 along an F45-F45 line in FIG. 44. FIG. 45 shows the patch layer 40. In the present embodiment, the structure of the patch layer 40 is the same as that in the sixteenth embodiment except for the size thereof.

In the present embodiment, x7=23 mm is set. g9=0.5 mm is set. g10=1 mm is set. s3=1 mm is set. s4=17 mm is set. x8=21 mm is set. The dielectric constant of the insulating layers 60 and 300 is 4.4 and the dielectric dissipation factor thereof is 0.018.

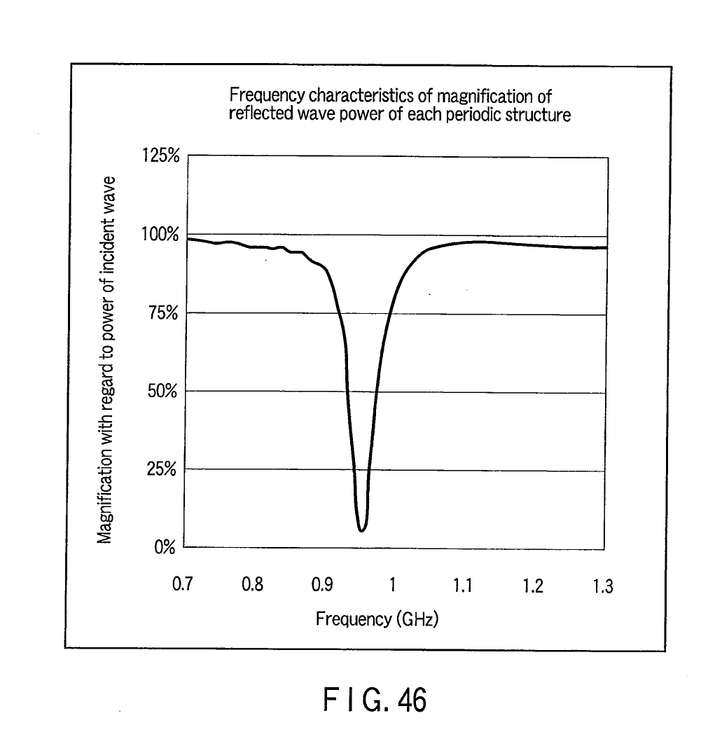

FIG. 46 is similar to FIG. 7 used in the third embodiment and is a graph showing a simulation result of frequency characteristics of reflected power attenuation at a position 157 mm over the surface 11 (in the direction opposite to the direction toward the ground layer 50) of the periodic structure 10. The periodic structure 10 in the present embodiment is configured for the purpose of controlling reflected waves when the frequency of an incident wave is 953 MHz (an example of the specific frequency in the present embodiment).

In the present embodiment, the same operation and effect as those in the sixteenth embodiment can be obtained. Further, the insulating layer 300 functions as a spacer that minimizes an influence to which the LC resonance circuits 230 and 240 are subjected from surrounding objects. Moreover, covering the LC resonance circuits 230 and 240 with the insulating layer 300 also contributes to miniaturization of the LC resonance circuits 230 and 240 thanks to the wavelength shortening effect of an insulator by adjusting the dielectric constant of the insulating layer 300.

The insulating layer 300 is stacked on the periodic structure 10 according to the present embodiment, but the present embodiment is not limited to this. For example, the insulating layer 300 may be stacked on the patch layer 40 of the periodic structure 10 according to the fourteenth to sixteenth embodiments. In such a case, the same effect as that in the present embodiment can further be obtained.

In the thirteenth embodiment, a loss material is used as a dielectric material to form the first and second insulating layers 130 and 140. However, in the other embodiments (the fifth to thirteenth, eighteenth, and nineteenth embodiments) having a structure including the first and second insulating layers 130 and 140, the same effect as that in the thirteenth embodiment can further be obtained by using the same loss material in the thirteenth embodiment as a dielectric material to form the insulating layers 130 and 140. Similarly, in the other embodiments (the first to fourth, fourteenth to seventeenth, and twentieth embodiments) including the insulating layer 60, the same effect as that in the thirteenth embodiment can further be obtained by using the same loss material in the thirteenth embodiment for the insulating layer 60.

In the other embodiments having a structure including a plurality of insulating layers, for example, including the insulating layers 60 and 300 (the seventeenth and twentieth embodiments), the insulating layers 130 and 140 (the fifth to thirteenth, eighteenth, and nineteenth embodiments), and the insulating layers 130, 140, and 300 (the eighteenth and nineteenth embodiments), the same effect as that in the thirteenth embodiment can further be obtained by using the same loss material in the thirteenth embodiment for one dielectric material formed in the plurality of insulating layers.

In the first to seventeenth, nineteenth, and twentieth embodiments, the periodic structure 10 includes two types of LC resonance circuits. In the eighteenth embodiment, three types of LC resonance circuits are provided. However, the present embodiment is not limited to such examples. Also in these embodiments, a different plurality such as three or four of LC resonance circuits may be provided. In such a case, the plurality of LC resonance circuits is designed so that reflected waves reflected by each type of LC resonance circuits cancel out each other.

Thus, even with a structure including a different plurality such as three or four of LC resonance circuits, it becomes possible to improve the environment of communication by controlling radio interference caused by reflected waves.

By setting the phase difference of a reflected wave with regard to an incident wave of at least one type of LC resonance circuit in each embodiment of a plurality of types (two types or more) of LC resonance circuits whose phase difference with regard to the incident wave is mutually different included in each of the first to twentieth embodiments to a value of −90 degrees or more and 90 degrees or less, canceling-out of reflected waves is further promoted.

This is because waves reflected off a normal metal plate have a phase difference of about 180 degrees with regard to an incident wave and if, as described above, the phase difference of at least one type of reflected wave with regard to the incident wave is a value in the range of −90 degrees or more and 90 degrees or less, canceling-out of reflected waves is further promoted.

To set the phase difference to a value of −90 degrees or more and 90 degrees or less, as described in each of the above embodiments, the width of a gap forming an LC resonance circuit is adjusted or the length of a conductor patch is adjusted. In the fifth embodiment, a conductor patch unit 500 includes the combination of the first conductor patches 112 adjacent to each other. In the seventh embodiment, the conductor patch unit 500 includes two combinations 600. Each of the combinations 600 includes two first conductor patches 112 adjacent to each other. The conductor patch unit 500 may comprise a plurality of combinations, for example three or four combinations.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A periodic structure comprising:
two types of LC resonance circuits or more, wherein phases of reflected waves by these two types of LC resonance circuits or more with regard to an incident wave comprising a specific frequency are different for each type of the LC resonance circuit.

2. The periodic structure according to claim 1, further comprising:
a patch layer including a plurality of conductor patches in which these conductor patches are arranged with a gap between the conductor patches adjacent to each other;
a ground layer spaced with respect to the patch layer;
an insulating layer provided between the patch layer and the ground layer; and
a connecting conductor that electrically connects a contour portion of the conductor patches and the ground layer,
wherein the LC resonance circuit includes the gap between the conductor patches adjacent to each other and a current path comprising the conductor patches adjacent to each other to define the gap, the ground layer and the connecting conductor electrically connecting the conductor patches and the ground layer.

3. The periodic structure according to claim 1, further comprising:
a first patch layer including a plurality of first conductor patches in which these first conductor patches are arranged with a gap between the first conductor patches adjacent to each other;
a second patch layer spaced from the first patch layer and including a plurality of second conductor patches in which these second conductor patches are arranged with the gap between the second conductor patches adjacent to each other;
a ground layer provided on a side opposite to the first patch layer by sandwiching the second patch layer therebetween;
a first insulating layer provided between the first patch layer and the second patch layer;
a second insulating layer provided between the second patch layer and the ground layer; and
a connecting conductor provided in each of the first conductor patches, wherein the connecting conductor electrically connects a conductor patch unit including at least a combination comprising the first conductor patches adjacent to each other or more of the plurality of first conductor patches and in which the combinations are adjacent to each other to the one common second conductor patch of the plurality of second conductor patches by a direct current,
wherein one type of LC resonance circuit of the two types of LC resonance circuits or more includes a first gap defined between a pair of the first conductor patches electrically connected by the direct current via the connecting conductor and the second conductor patches, and
another at least one type of LC resonance circuit includes a second gap defined between the first conductor patches not electrically connected by the direct current of the first conductor patches adjacent to each other.

4. The periodic structure according to claim 1, further comprising:
a patch layer including a plurality of conductor patches in which the conductor patches are arranged with a gap between the conductor patches adjacent to each other;
a ground layer spaced with respect to the patch layer; and
an insulating layer provided between the patch layer and the ground layer,
wherein a groove passing through the conductor patch is formed inside the conductor patch,
at least one type of the two types of LC resonance circuits or more includes the gap between the conductor patches adjacent to each other, and
another at least one type of LC resonance circuit includes the groove of the conductor patch.

5. The periodic structure according to claim 1,
wherein the LC resonance circuit has an insulating layer further stacked thereon.

6. The periodic structure according to claim 2,
wherein the LC resonance circuit has an insulating layer further stacked thereon.

7. The periodic structure according to claim 3,
wherein the LC resonance circuit has an insulating layer further stacked thereon.

8. The periodic structure according to claim 4,
wherein the LC resonance circuit has an insulating layer further stacked thereon.

9. The periodic structure according to claim 2,
wherein the insulating layer is formed of a loss material.

10. The periodic structure according to claim 3,
wherein at least one of the first and second insulating layers is formed of a loss material.

11. The periodic structure according to claim 4,
wherein at least one of the first and second insulating layers is formed of a loss material.

12. The periodic structure according to claim 5,
wherein the further stacked insulating layer is formed of a loss material.

13. The periodic structure according to claim 6,
wherein the further stacked insulating layer is formed of a loss material.

14. The periodic structure according to claim 7,
wherein the further stacked insulating layer is formed of a loss material.

15. The periodic structure according to claim 8,
wherein the further stacked insulating layer is formed of a loss material.

16. The periodic structure according to claim 1,
wherein a phase difference of the reflected waves with regard to the incident wave of at least one type of LC resonance circuit of the two types of LC resonance circuits or more becomes a value in a range of −90 degrees or more and 90 degrees or less.
